(19) United States
(12) Patent Application Publication
(10) Pub. No.: US 2026/0253617 A1
(43) Pub. Date: Aug. 27, 2026

(54) SYSTEM AND METHOD FOR TAGGING MULTIMEDIA CONTENT

(71) Applicant: HUMANIFY TECHNOLOGIES PVT LTD, Mumbai (IN)

(72) Inventor: Geetika KAMBLI, Mumbai (IN)

(21) Appl. No.: 18/870,481

(22) PCT Filed: May 26, 2023
(86) PCT No.: PCT/IN2023/050507

§ 371 Date: Nov. 29, 2024

(30) Foreign Application Priority Data
May 31, 2022 (IN) 202221031258

(51) Int. Cl. G11B 27/34; H04N 21/2187; H04N 21/8549; H04N 21/858

(52) U.S. Cl. CPC G11B 27/34; H04N 21/2187; H04N 21/8549; H04N 21/858

(57) ABSTRACT

A system for tagging multimedia content is provided. The system comprises a memory and an application server that records a multimedia content indicative of a live user interview. The application server determines a start and an end of a portion of the multimedia content that is to be tagged. Further, the application server generates a first multimedia clip including the portion of multimedia content that is recorded between the determined start and end. The application server identifies a first tag that is indicative of a context of the first multimedia clip, links the first tag with the first multimedia clip, and stores the first multimedia clip and the corresponding first tag in the memory.

### CROSS-RELATED APPLICATIONS

This application claims priority of Indian Provisional Application No. 202221031258 filed May 31, 2022, the contents of which are incorporated herein by reference.

### FIELD OF THE DISCLOSURE

Various embodiments of the disclosure relate generally to processing of multimedia content. More specifically, various embodiments of the disclosure relate to methods and systems for tagging portions of multimedia content based on context thereof.

### BACKGROUND

Multimedia content (for example, videos, audio, or the like) is recorded for various purposes such as interviews, feedback, survey, research, or the like. The multimedia content may include information associated with various topics. Typically, an individual who wishes to access specific topics may have to examine the whole content to identify portions of the multimedia content related to such topics. Such an examination of the multimedia content may be time-consuming and inefficient. Also, the individual may miss a few relevant portions during the examination, thereby degrading the effectiveness and accuracy of the interview, feedback, survey, research, or the like. Therefore, it becomes difficult to accurately retrieve all the relevant information from the multimedia content. Further, the manual examination of the multimedia content may be impractical and non-scalable in cases where the bulk of multimedia content is to be examined.

In light of the foregoing, there exists a need for a technical and reliable solution that overcomes the abovementioned problems, and ensures efficient retrieval of relevant information from the multimedia content.

Limitations and disadvantages of conventional and traditional approaches will become apparent to one of skill in the art, through comparison of described systems with some aspects of the present disclosure, as set forth in the remainder of the present application and with reference to the drawings.

### SUMMARY

Methods and systems for tagging multimedia content (for example, a video) are provided substantially as shown in, and described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

Embodiments of the present invention are illustrated by way of example and are not limited by the accompanying figures. Similar references in the figures may indicate similar elements. Elements in the figures are illustrated for simplicity and clarity and have not necessarily been drawn to scale.

FIG. 1 is a block diagram that illustrates a system environment for tagging a multimedia content, in accordance with an embodiment of the disclosure;

FIGS. 2A-2M are schematic diagrams that illustrate various interface screens of an organizer interface of a service application, in accordance with an embodiment of the disclosure;

FIGS. 3A-3C are schematic diagrams that illustrate various interface screens of a client interface of the service application, in accordance with an embodiment of the disclosure;

FIGS. 4A and 4B, collectively, illustrate an exemplary scenario for tagging the multimedia content, in accordance with an embodiment of the disclosure;

FIG. 5 is a block diagram that illustrates a system application of a computer system for tagging the multimedia content, in accordance with an embodiment of the disclosure;

FIG. 6 is a flowchart that illustrates a method for tagging the multimedia content, in accordance with an embodiment of the disclosure; and FIG. 7 is a block diagram that illustrates the system environment for tagging the multimedia content, in accordance with another embodiment of the disclosure.

Further areas of applicability of the present disclosure will become apparent from the detailed description provided hereinafter. It should be understood that the detailed description of embodiments is intended for illustration purposes only and is, therefore, not intended to necessarily limit the scope of the disclosure.

### DETAILED DESCRIPTION

The present disclosure discloses a system for tagging a multimedia content. The disclosed system includes an application server and a memory associated with the application server. The multimedia content is indicative of a live user interview of a respondent. The application server may record the multimedia content. The application server may determine a first alert associated with the multimedia content at a first time instance. The first alert may be indicative of a start of a portion of the multimedia content that is to be tagged. The application server may further determine a second time instance that corresponds to an end of the portion of the multimedia content that is to be tagged. Based on the determined start and end of the portion of the multimedia content that is to be tagged, the application server may generate a multimedia clip from the recorded multimedia content. Further, for the generated multimedia clip, the application server may identify a tag from a plurality of tags based on a context of the generated multimedia clip. The application server may link the identified tag with the generated multimedia clip and store the generated multimedia clip and the corresponding tag in the memory.

The methods and systems of the disclosure provide easy and quick access to a desired portion of the multimedia content. Further, the tags associated with the portions of the multimedia content may be indicative of the context of the corresponding portion. Hence, such tagging of the multimedia content reduces the requirement of manually accessing the multimedia content for retrieving relevant information, thereby increasing the effectiveness and accuracy of multimedia data collection performed to serve different purposes associated with surveys, interviews, research, or the like. Further, such tagging saves a significant amount of time by indicating the context of the multimedia content as users need not access irrelevant or random multimedia content. As a result, the multimedia content tagging method of the present disclosure is scalable and efficient in cases where a significant number of live user interviews are to be conducted.

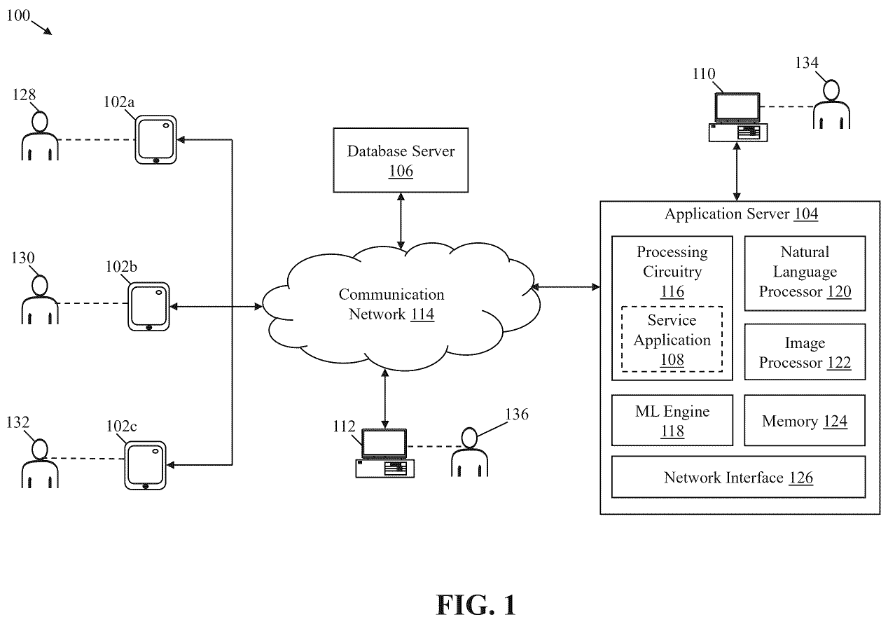

FIG. 1 is a block diagram that illustrates a system environment 100 for tagging a multimedia content, in accordance with an embodiment of the disclosure. The system environment 100 may include a plurality of user devices 102 (e.g., first through third user devices 102a-102c), an application server 104, and a database server 106. The application server 104 may be configured to host a service application 108. The system environment 100 may further include an administrator device 110, an organizer device 112, and a communication network 114. The plurality of user devices 102, the application server 104, the database server 106, the administrator device 110, and the organizer device 112 may communicate with each other by way of the communication network 114. Further, the application server 104 may include processing circuitry 116, a machine learning (ML) engine 118, a natural language processor 120, an image processor 122, a memory 124, and a network interface 126.

The first user device 102a may include suitable logic, circuitry, interfaces, and/or code, executable by the circuitry, that may be configured to execute one or more instructions. For example, the first user device 102a may be configured to execute the service application 108 that is hosted by the application server 104. In one embodiment, the service application 108 is a standalone application installed on the first user device 102a. In another embodiment, the service application 108 is accessible by way of a web browser installed on the first user device 102a. The first user device 102a may be further configured to access a client interface of the service application 108 that allows a first user 128 (hereinafter referred to as a ‘first respondent 128’) to provide information (such as voice, video, or the like) for the multimedia content. Examples of the first user device 102a may include, but are not limited to, a personal computer, a laptop, a smartphone, a tablet, or the like. The second and third user devices 102b and 102c may be functionally similar to the first user device 102a and associated with second and third respondents 130 and 132, respectively. For the sake of brevity, the ongoing description is described with respect to the first user device 102a. In other embodiments, operations being performed by the first user device 102a may be performed by any of the second and third user devices 102b and 102c, without deviating from the scope of the present disclosure.

The application server 104 may include suitable logic, circuitry, interfaces, and/or code, executable by the circuitry, that may be configured to host the service application 108. The application server 104 may be implemented by one or more processors, such as, but not limited to, an application-specific integrated circuit (ASIC) processor, a reduced instruction set computer (RISC) processor, a complex instruction set computer (CISC) processor, and a field programmable gate array (FPGA) processor. The one or more processors may also correspond to central processing units (CPUs), graphics processing units (GPUs), neural processing units (NPUs), digital signal processors (DSPs), or the like. It will be apparent to a person of ordinary skill in the art that the application server 104 may be compatible with multiple operating systems.

The application server 104 may be further communicably coupled to the administrator device 110. The administrator device 110 may be used by an administrator 134 of the disclosed system environment 100 to administer and/or manage the service application 108. The administrator device 110 may be used by the administrator 134 to design one or more forms, layouts, interfaces, or the like, that facilitate tagging the multimedia content. The administrator device 110 may be configured to provide access to an administrator interface of the service application 108. The administrator interface of the service application 108 allows the administrator 134 to design different forms, interfaces, layouts, or the like, that may be used by an organizer 136 of a project to organize, administrate, and manage the tagging of the multimedia content.

The application server 104 may be further communicably coupled to a plurality of organizer devices of which one organizer device 112 is shown. The organizer device 112 may be associated with the organizer 136 responsible for designing and executing the collection of multimedia content. The organizer device 112 may present an organizer interface of the service application 108 to the organizer 136. The organizer device 112 may be configured to receive one or more inputs to populate the forms, layouts, and interfaces designed by the administrator 134, with tags, questions, or the like, that may be relevant to the collection of the multimedia content. In some embodiments, the organizer interface may allow for manual tagging and/or labeling of the portions of the multimedia content. In some embodiments, the organizer interface of the service application 108 may allow the organizer 136 to review the tagging of different portions of the multimedia content. In an embodiment, the communication via the communication network 114 is indicative of the collection of the multimedia content being remote. That is to say that the users (e.g., the first through third respondents 128-132) and the organizer 136 exist in different geographical locations while the multimedia content is recorded.

The application server 104 may be further configured to receive various information from the first respondent 128 by way of the client interface of the service application 108 installed on the first user device 102a. The information being received from the first user device 102a may correspond to a live user interview (for example, a live video interview) between the first respondent 128 and the organizer 136, with the first respondent 128 being remotely located with respect to the organizer 136. Such a live user interview is referred to as the multimedia content. The multimedia content may be associated with various objectives such as feedback, a survey, an interview, or the like. Thus, the application server 104 may be further configured to receive, over the communication network 114, the multimedia content from the first user device 102a of the first respondent 128 during the live user interview. The live user interview may be conducted for gathering user information regarding a domain associated with the multimedia content from the first respondent 128. The domain of the multimedia content is same as the domain of the live user interview.

The application server 104 may be further configured to receive the domain of the live user interview and a plurality of tags associated with the domain via the organizer device 112. Each tag of the plurality of tags is indicative of at least one of a subject, an objective, or a keyword associated with the domain of the live user interview. The processing circuitry 116 may receive the domain and the plurality of tags prior to the live user interview. The domain may refer to a broad area pertaining to scientific industry, marketing industry, culinary industry, aviation industry, or the like. In an example, a domain associated with the live user interview may be ‘aviation industry’. Therefore, the plurality of tags may include two or more tags pertaining to the aviation industry. The plurality of tags may include, for example, ‘safety’, ‘experience’, ‘travel time’, ‘luggage handling’, ‘leg room’, ‘air craft’, or the like. Thus, prior to the live user interview, the application server 104 may allow the organizer 136 to pre-define one or more topics and tags associated with the domain of the live user interview.

The application server 104 may be further configured to record the multimedia content that is indicative of the live user interview of the first respondent 128. While the multimedia content is being recorded, the application server 104 may be further configured to determine a first alert associated with the multimedia content at a first time instance. The first alert is indicative of a start of a portion of the multimedia content that is to be tagged. Subsequently, the application server 104 may be configured to determine a second time instance that corresponds to an end of the portion of the multimedia content that is to be tagged. The second time instance occurs after the first time instance.

In some embodiments, the first alert may correspond to an input received via the organizer device 112. The input may be provided by the organizer 136 at the first time instance. Reception of the first alert by the application server 104 may be indicative of the start of the portion of the multimedia content that is to be tagged. In one embodiment, the start of the portion of the multimedia content that is to be tagged is at the first time instance. In another embodiment, the start of the portion of the multimedia content that is to be tagged is at a gap of a first predefined time interval from the first time instance. In an example, the start of the portion to be tagged is 2 seconds before the reception of the first alert. In another example, the start of the portion to be tagged is 2 seconds after the reception of the first alert. Additional examples of the first predefined time interval may include 5 seconds, 10 seconds, and so on.

In such cases, the second time instance may be determined based on another input from the organizer 136. For example, the application server 104 may be further configured to receive, via the organizer device 112 of the organizer 136, a second alert associated with the multimedia content at the second time instance. The second alert may be indicative of the end of the portion of the multimedia content that is to be tagged. Further, the first and second alerts are received while the multimedia content is being recorded. The second time instance may be determined by the application server 104 based on the reception of the second alert. In one embodiment, the end of the portion of the multimedia content that is to be tagged is at the second time instance. In another embodiment, the end of the portion of the multimedia content that is to be tagged is at a gap of a second predefined time interval from the second time instance. In an example, the end of the portion to be tagged is 2 seconds before the second time instance. In another example, the end of the portion to be tagged is 2 seconds after the second time instance. Additional examples of the second predefined time interval may include 5 seconds, 10 seconds, and so on.

In some embodiments, the first alert may be determined based on a detection of a trigger in the live user interview. The trigger may include at least one of a gesture, a facial expression, and one or more predefined keywords used by the first respondent 128 in the live user interview. The trigger may be defined by at least one of the administrator 134 via the administrator device 110 or the organizer 136 via the organizer device 112. The detection of the trigger is indicative of the start of the portion of the multimedia content that is to be tagged. In such cases, the second time instance may be determined based on another trigger from the first respondent 128 or the organizer 136. This trigger may be the same or different from the trigger utilized for determining the start of the portion of the multimedia content to be tagged.

The scope of the present disclosure is not limited to the second time instance being determined based on the inputs/triggers from the organizer 136 and/or the first respondent 128. In an alternate embodiment, the second time instance is determined by the application server 104 to be at a predefined time duration after the first time instance. Examples of the predefined time duration may include 30 seconds, 60 seconds, 90 seconds, or the like.

It will be apparent to a person of skill in the art that the determination of the first time instance and the determination of the second time instance may be performed by the application server 104 in different manners. In an example, the first time instance may be determined based on an input received via the organizer device 112 and the second time instance may be determined to be a predefined time interval (for example, 2 minutes) from the first time instance. In another example, the first time instance may be determined based on a detection of a trigger (for example, a gesture) in the multimedia content and the second time instance may be determined based on a detection of another trigger (for example, a keyword) in the multimedia content.

The application server 104 may be further configured to generate a first multimedia clip that includes the portion of the multimedia content that is to be tagged. The first multimedia clip may be generated based on the recorded multimedia content (e.g., after the recording of the live user interview is complete). In some embodiments, the application server 104 may be configured to generate the first multimedia clip while the live user interview is in progress. In such embodiments, the first multimedia clip may be generated once the portion of the multimedia content that is to be tagged gets recorded by the application server 104. Subsequently, the application server 104 may be configured to identify, from the plurality of tags, one or more tags that may be relevant to the first multimedia clip. The identified one or more tags may be contextually descriptive or indicative of a context of the first multimedia clip. For example, the application server 104 may be further configured to identify, from the plurality of tags, a first tag that is indicative of the context of the first multimedia clip. In some embodiments, the application server 104 may be configured to store the plurality of tags in the memory 124 associated therewith. Each tag of the plurality of tags is indicative of at least one context associated with the multimedia content. The application server 104 may be further configured to receive, via the organizer device 112, a context indicator that is indicative of the context of the portion of the multimedia content to be tagged. The first tag may be identified from the plurality of tags based on the context indicator. The context indicator may be received in conjunction with the first alert, and thus, the first tag may be identified based on the first alert.

Although it is described that the application server 104 determines the context of the first multimedia clip based on the context indicator received from the organizer 136, the scope of the present disclosure is not limited to it. In other embodiments, the application server 104 may be configured to determine the context of the first multimedia clip based on presence of one or more keywords present in the first multimedia clip, a sequence of occurrence of the first multimedia clip in the multimedia content, an input provided by the first respondent 128 via the first user device 102a, a topic being discussed in the first multimedia clip, or the like.

The application server 104 may be further configured to link the identified first tag with the first multimedia clip. Further, the application server 104 may be configured to store the first multimedia clip and the corresponding first tag in the memory 124. Additionally, while the recording is ongoing, the application server 104 may be further configured to receive, after the first alert, a label via the organizer device 112. The label corresponds to one or more characteristics, that are different from the first tag, assigned to the portion of the multimedia content that is to be tagged. The label may be a note or an identifier associated with the portion of the multimedia content that is to be tagged. The application server 104 may be further configured to link the label with the first multimedia clip and store, in conjunction with the first multimedia clip and the first tag, the label in the memory 124. It will be apparent to a person of skill in the art that different labels may be received for different portions of the multimedia content that are to be tagged. In an example, the first multimedia clip may include a portion of the multimedia content where the first respondent 128 may be describing the hair dryer. The organizer 136 may provide a label ‘General Description’ via the organizer device 112 to be associated with the first multimedia clip. The label ‘General Description’ may be indicative of a content of the first multimedia clip. The label may be used for internal operations and to avail additional information about the first multimedia clip.

The application server 104 may similarly generate multiple multimedia clips from the same live user interview. For example, the application server 104 may be further configured to generate a second multimedia clip that includes a portion of the multimedia content corresponding to a time interval between a third time instance and a fourth time instance, identify, from the plurality of tags, a second tag that is indicative of a context of the second multimedia clip, and link the second tag with the second multimedia clip.

After the recording of the multimedia content is complete, the application server 104 may be further configured to present, on the organizer device 112, the multimedia content having the first and second multimedia clips with the first and second tags, respectively. The organizer 136 may then verify each clip. Thus, the application server 104 may be further configured to receive, via the organizer device 112, an input that verifies the first tag and the start and the end of the first multimedia clip and the second tag and the start and the end of the second multimedia clip.

Additionally, the application server 104 may enable the organizer 136 to add new tags or modify existing tags. For example, in one scenario, the application server 104 may be further configured to receive a third tag via the organizer device 112 for the first multimedia clip, link the third tag with the first multimedia clip, and store the first multimedia clip and the corresponding third tag in the memory 124. Further, in another scenario, the application server 104 may be configured to receive, via the organizer device 112, an input indicative of an instruction to delink the first tag from the first multimedia clip and update the first multimedia clip and the corresponding first tag stored in the memory 124 to delink the first tag from the first multimedia clip. In yet another scenario, the application server 104 may be configured to receive, via the organizer device 112, an input indicative of an instruction to delink the first tag from the first multimedia clip and link a fourth tag to the first multimedia clip. The application server 104 may be further configured to update the first multimedia clip and the corresponding first tag stored in the memory 124 to delink the first tag from the first multimedia clip, link the fourth tag with the first multimedia clip, and store the first multimedia clip and the corresponding fourth tag in the memory 124.

Although it is described that one multimedia clip is associated with one tag, the scope of the present disclosure is not limited to it. In other embodiments, the application server 104 may be further configured to identify, from the plurality of tags, based on the first alert, another tag (e.g., a fifth tag) that is indicative of the context of the first multimedia clip, link the fifth tag with the first multimedia clip, and store the first multimedia clip and the corresponding fifth tag in the memory 124.

Additionally, the application server 104 may enable the organizer 136 to add new clips or modify existing clips. For example, in one scenario, the application server 104 may be further configured to receive an input via the organizer device 112 to modify the first and/or second time instances and update the first multimedia clip in the memory 124 based on the received input. The modification may be to expand, shift, or contract the first multimedia clip. In another scenario, the application server 104 may be configured to receive two separate time instances indicative of a new multimedia clip and a tag associated therewith via the organizer device 112 and generate and store the new multimedia clip with the corresponding tag in the memory 124. The new multimedia clip may or may not coincide with existing multimedia clips.

The application server 104 may be further configured to determine one or more insights associated with the multimedia content based on an analysis of the first multimedia clip and the corresponding tags (e.g., the first tag, the third tag, the fourth tag, and/or the fifth tag) and the second multimedia clip and the corresponding second tag. Further, the application server 104 may be configured to present, on the organizer device 112, the one or more insights to the organizer 136. The real-time tagging of the multimedia content thus enables accurate and efficient analysis of the live user interview. In an example, the first multimedia clip may include a description of the hair dryer, and the second multimedia clip may include a description of how the product is being used for different purposes. Therefore, upon analysis of the first multimedia clip and the second multimedia clip, the application server 104 may derive a first insight that a first hair dryer is used for drying hair, a second insight that a second hair dryer is used for drying hair as well as styling hair, and a third insight that the second hair dryer is more favored than the first hair dryer.

To execute the aforementioned operations, the application server 104 may include the processing circuitry 116, the ML engine 118, the natural language processor 120, the image processor 122, and the network interface 126. In other embodiments, the application server 104 may include additional or different components configured to perform similar or different operations.

The processing circuitry 116 may include suitable logic, circuitry, interfaces, and/or code, executable by the circuitry, that may be configured to execute one or more instructions stored in the memory 124 to perform various operations for tagging the multimedia content. The processing circuitry 116 may be configured to host the service application 108 and execute various operations associated with multimedia content collection and processing. The processing circuitry 116 may be implemented by one or more processors, such as, but not limited to, an ASIC processor, a RISC processor, a CISC processor, and an FPGA processor. The one or more processors may also correspond to CPUs, GPUs, NPUs, DSPs, or the like. It will be apparent to a person of ordinary skill in the art that the processing circuitry 116 is compatible with multiple operating systems.

The processing circuitry 116 may be further configured to receive the domain of the live user interview and the plurality of tags associated with the domain via the organizer device 112. The processing circuitry 116 may be further configured to record the multimedia content associated with the live user interview. The multimedia content may include interaction between the first respondent 128 and the organizer 136. The processing circuitry 116 may be further configured to determine the first alert associated with the multimedia content at the first time instance. The first alert is indicative of the start of the portion of the multimedia content that is to be tagged. The processing circuitry 116 may be further configured to determine the second time instance that is indicative of the end of the portion of the multimedia content that is to be tagged. Further, the processing circuitry 116 may be configured to generate the first multimedia clip that includes the portion of the multimedia content to be tagged. Subsequently, the processing circuitry 116 may be configured to identify at least the first tag from the plurality of tags based on the context of the first multimedia clip and link the identified first tag with the first multimedia clip. In an embodiment, the first tag is linked to the first multimedia clip by creating a table and storing a record of the first multimedia clip in the table, and inserting the first tag corresponding to the record of the first multimedia clip. Subsequently, the processing circuitry 116 may be configured to store the first multimedia clip and the corresponding first tag in at least one of the database server 106 and the memory 124. The processing circuitry 116 may be further configured to execute various operations associated with the addition and modification of the tags and the multimedia clips. Additionally, the processing circuitry 116 may be configured to determine the one or more insights associated with the multimedia content based on an analysis of the generated multimedia clips and associated tags and/or labels, and present, on the organizer device 112, the one or more insights to the organizer 136.

The ML engine 118 may include suitable logic, circuitry, interfaces, and/or code, executable by the circuitry, that is configured to perform one or more operations for optimizing the determination of the first alert (e.g., the first time instance) and the second time instance. The ML engine 118 may optimize the determination of the first and second time instances such that the start and the end of the portion that is to be tagged are indicated with significant precision. Further, the ML engine 118 may perform supervised or unsupervised learning for improving the detection of keywords, gestures, expressions, actions, or the like, in the multimedia content for detection of the first and second time instances (e.g., the first and second alerts).

In some embodiments, the ML engine 118 may be configured to analyze historical user interviews to deduce a pattern or flow of interviews being conducted by the organizer 136. In some embodiments, the ML engine 118 may be configured to analyze the historical user interviews to deduce a pattern or flow of interviews being conducted for specific products. In some embodiments, the ML engine 118 may be configured to analyze the historical user interviews to deduce a pattern or flow of interviews being conducted for one or more topics associated with a domain of the historical user interviews. In some embodiments, the ML engine 118 may be configured to analyze the historical user interviews conducted for accomplishing a given objective to deduce a pattern or flow of interviews being conducted to achieve the given objective. In such embodiments, the ML engine 118 may be configured to deduce one or more rules for the detection of the first alert and/or the second alert. For example, the ML engine 118 may determine, based on the historical user interviews conducted by the organizer 136, that the organizer 136 discusses the product first and subsequently discusses applications of the product. Therefore, the ML engine 118 may deduce a rule that the first multimedia clip of the live user interview conducted by the organizer 136 may have a context ‘description of product’, and hence, is tagged with a tag associated with the context ‘description of product’. The ML engine 118 may further determine that the second multimedia clip of the live user interview conducted by the organizer 136 may have a context ‘Applications of the product’, and hence, the second multimedia clip should be tagged with a tag associated with the context ‘Applications of the product’.

The natural language processor 120 may include suitable logic, circuitry, interfaces, and/or code, executable by the circuitry, that may be configured to perform one or more operations for identifying the one or more predefined keywords spoken in the live user interview by at least one of the first respondent 128 and the organizer 136. The natural language processor 120 may be configured to identify the one or more predefined keywords indicative of the start or the end of the portion of the multimedia content that is to be tagged. In some embodiments, the natural language processor 120 may be configured to identify synonyms of the one or more predefined keywords. In such embodiments, the synonyms of the one or more predefined keywords may be indicative of the start or the end of the portion of the multimedia content that is to be tagged.

The image processor 122 may include suitable logic, circuitry, interfaces, and/or code, executable by the circuitry, that may be configured to perform one or more operations for analyzing actions, gestures, expressions, or the like, being made during the live user interview. The image processor 122 may be configured to execute one or more image processing algorithms or techniques, on the multimedia content, to analyze the actions, gestures, expressions, or the like being made during the live user interview.

The processing circuitry 116 may be further configured to receive operational outputs of the ML engine 118, the natural language processor 120, and the image processor 122. The processing circuitry 116 may use the received operational outputs while performing various operations for tagging the multimedia content.

The memory 124 may include suitable logic, circuitry, and interfaces that may be configured to store one or more instructions which when executed by the processing circuitry 116, the ML engine 118, the natural language processor 120, and the image processor 122, cause the processing circuitry 116, the ML engine 118, the natural language processor 120, and the image processor 122, to perform various operations for tagging the multimedia content. The memory 124 may be configured to store the plurality of tags. The memory 124 may be further configured to store the multimedia clips and the associated tags and/or labels. The memory 124 is accessed via the organizer device 112. The memory 124 is accessed to view or modify the tagging of the multimedia clips via the organizer device 112. Examples of the memory 124 may include, but are not limited to, a random-access memory (RAM), a read-only memory (ROM), a removable storage drive, a hard disk drive (HDD), a flash memory, a solid-state memory, or the like. It will be apparent to a person skilled in the art that the scope of the disclosure is not limited to realizing the memory 124 in the application server 104, as described herein. In another embodiment, the memory 124 is realized in the form of the database server 106 or a cloud storage working in conjunction with the application server 104, without departing from the scope of the disclosure.

The network interface 126 may include suitable logic, circuitry, interfaces, and/or code, executable by the circuitry, that may be configured to enable the application server 104 to communicate with the first user device 102a, the database server 106, the administrator device 110, and the organizer device 112. The network interface 126 is implemented as hardware, software, firmware, or a combination thereof. Examples of the network interface 126 may include a network interface card, a physical port, a network interface device, an antenna, a radio frequency transceiver, a wireless transceiver, an Ethernet port, a universal serial bus (USB) port, or the like.

The database server 106 may include suitable logic, circuitry, interfaces, and/or code, executable by the circuitry, that may be configured to store the multimedia content and data (e.g., file name, date, context, or the like) associated therewith. Further, the database server 106 may be configured to perform one or more database operations (e.g., receiving, storing, sorting, viewing, transmitting, or the like) associated with the stored multimedia content and the associated data. Examples of the database server 106 may include, but are not limited to, a personal computer, a laptop, a mini-computer, a mainframe computer, a cloud-based server, a network of computer systems, or a non-transient and tangible machine executing a machine-readable code. The operations performed by the memory 124 may be performed by the database server 106 as well.

The communication network 114 may include suitable logic, circuitry, interfaces, and/or code, executable by the circuitry, that is configured to facilitate communication among various entities described in FIG. 1. Examples of the communication network 114 may include, but are not limited to, a wireless fidelity (Wi-Fi) network, a light fidelity (Li-Fi) network, a local area network (LAN), a wide area network (WAN), a metropolitan area network (MAN), a satellite network, the Internet, a fiber-optic network, a coaxial cable network, an infrared (IR) network, a radio frequency (RF) network, or a combination thereof. The entities in the system environment 100 may be communicatively coupled to the communication network 114 in accordance with various wired and wireless communication protocols, such as Transmission Control Protocol and Internet Protocol (TCP/IP), User Datagram Protocol (UDP), Long Term Evolution (LTE) communication protocols, or any combination thereof.

It will be apparent to a person skilled in the art that the system environment 100 described in conjunction with FIG. 1 is exemplary and does not limit the scope of the disclosure. In other embodiments, the system environment 100 may include different or additional components configured to perform similar or additional operations.

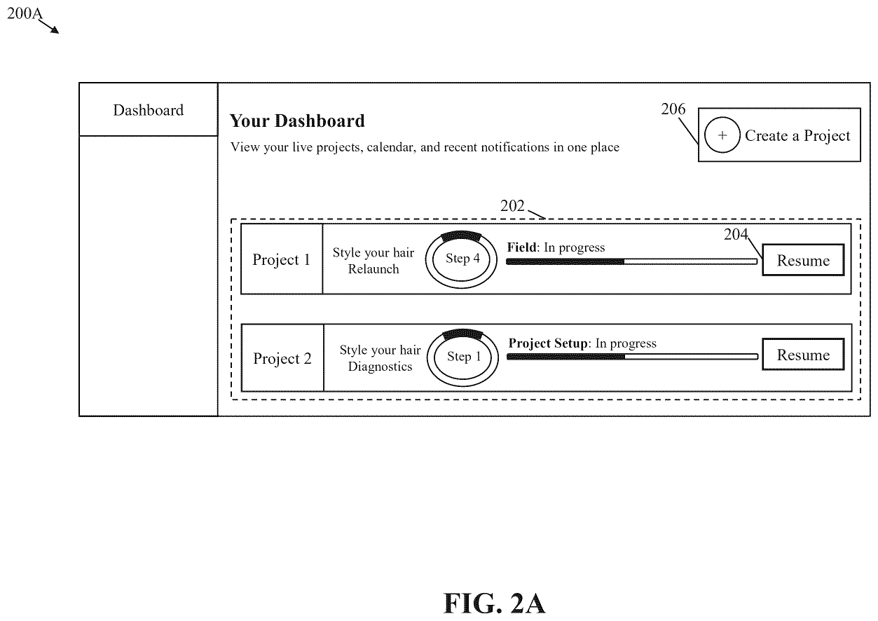

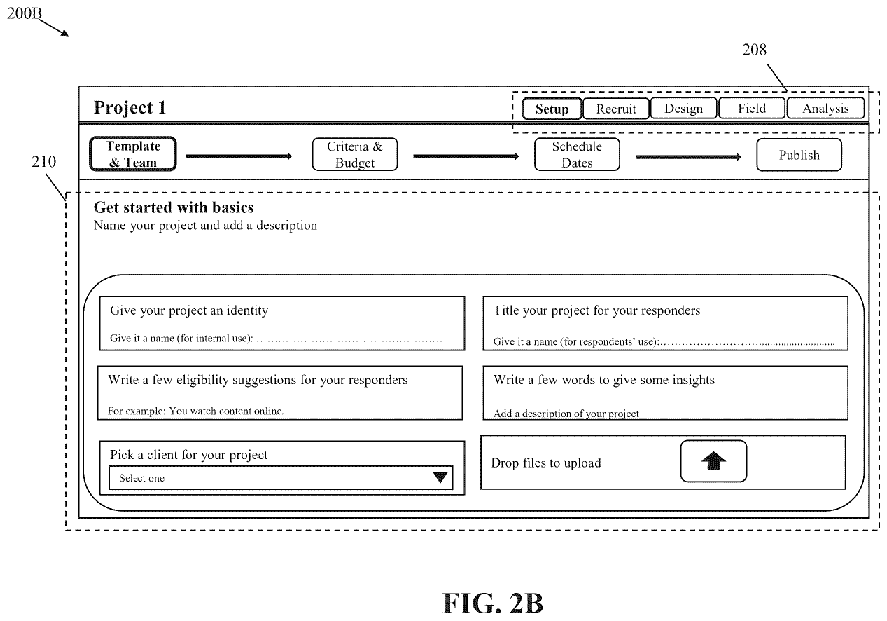

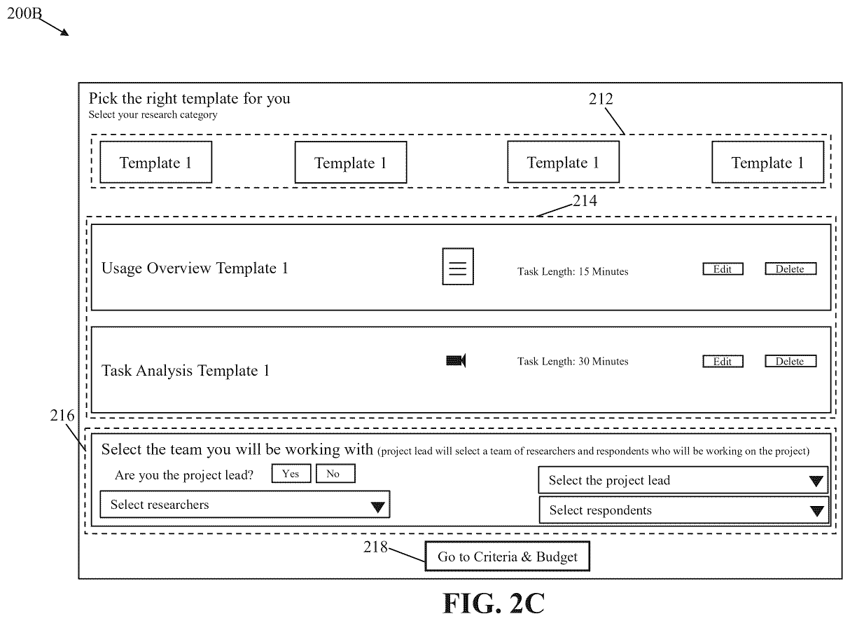

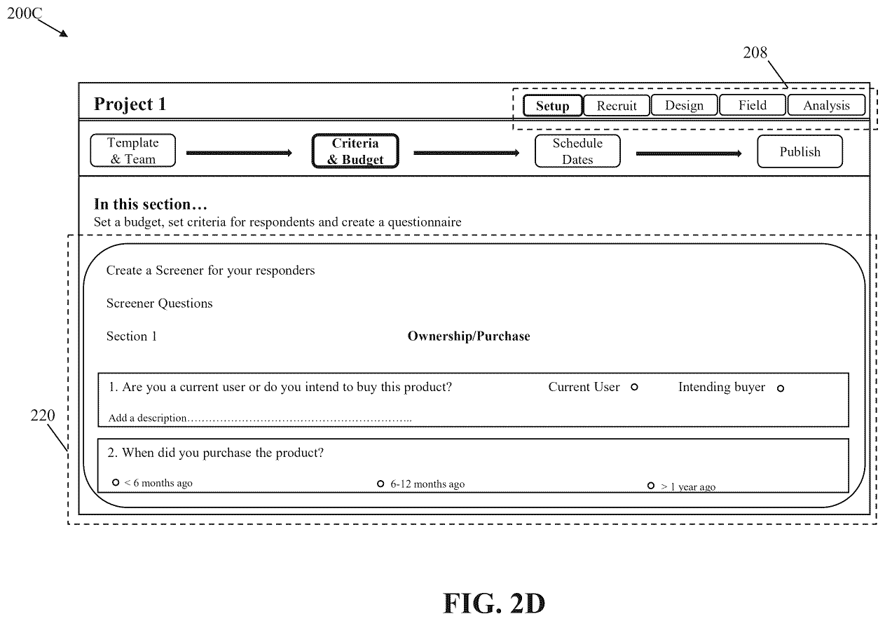

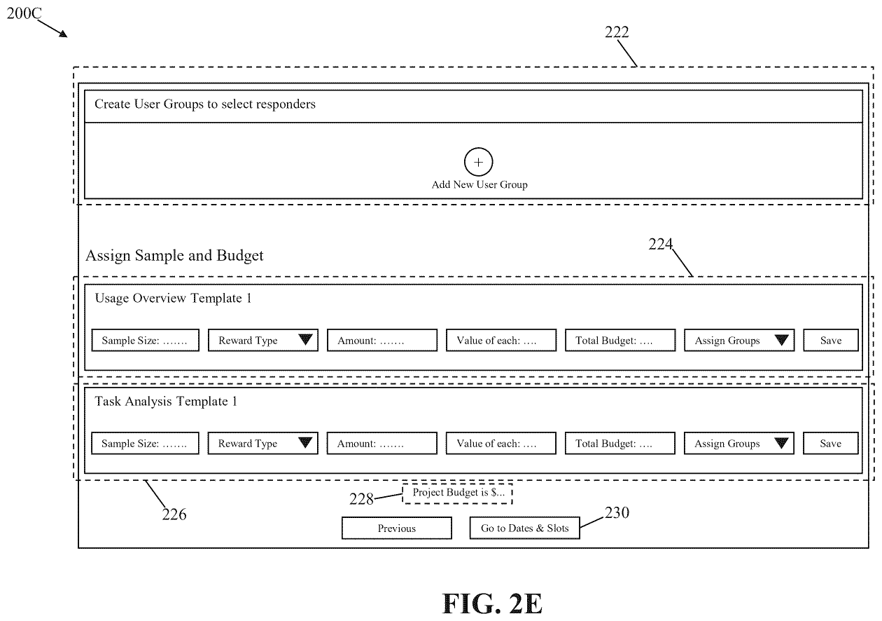

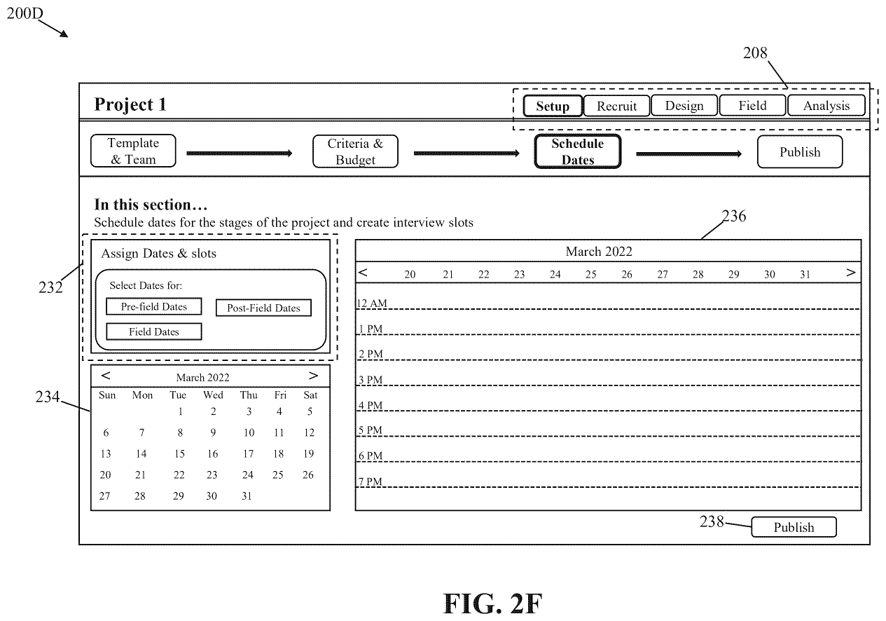

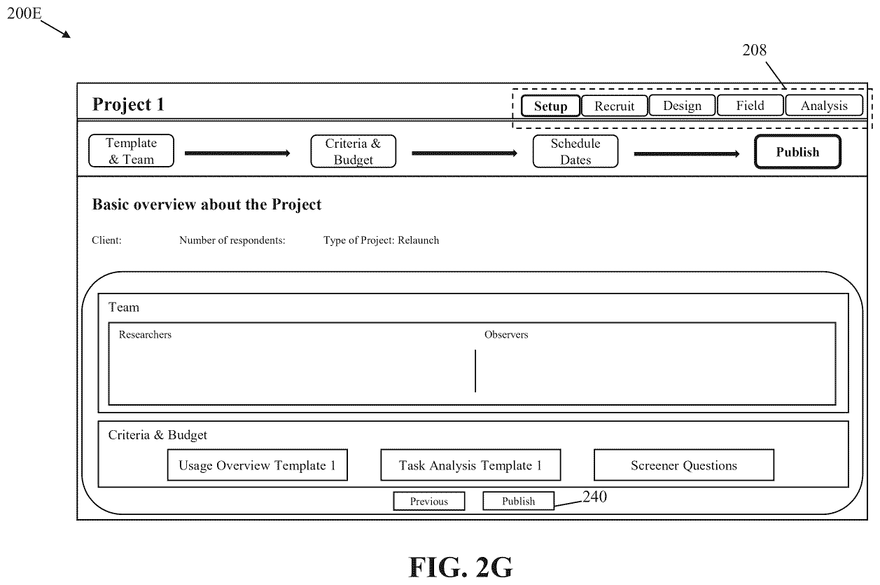

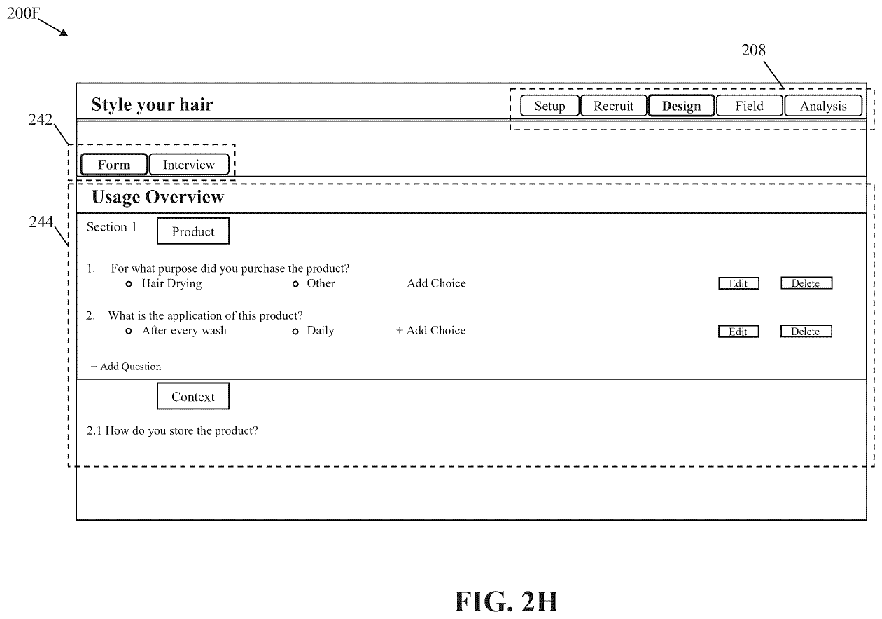

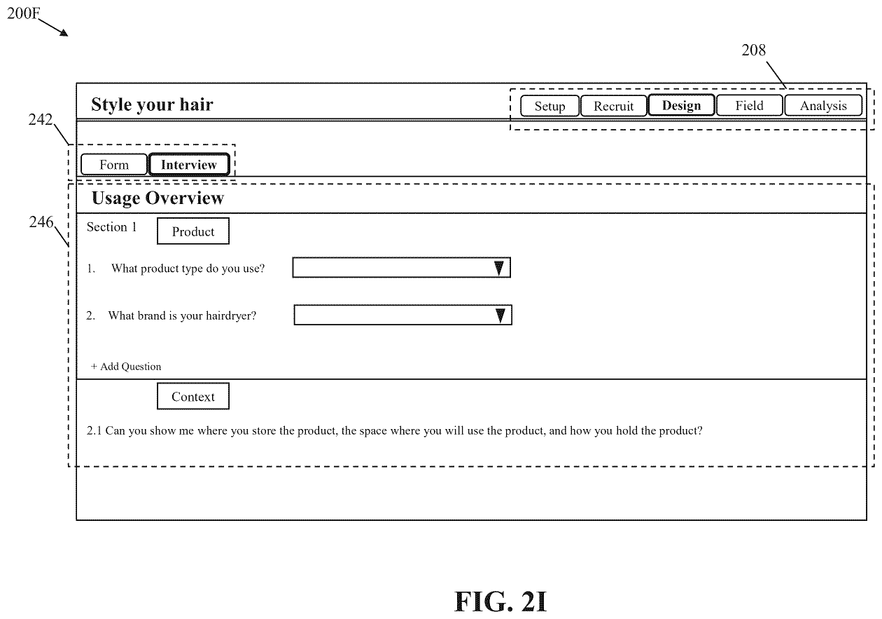

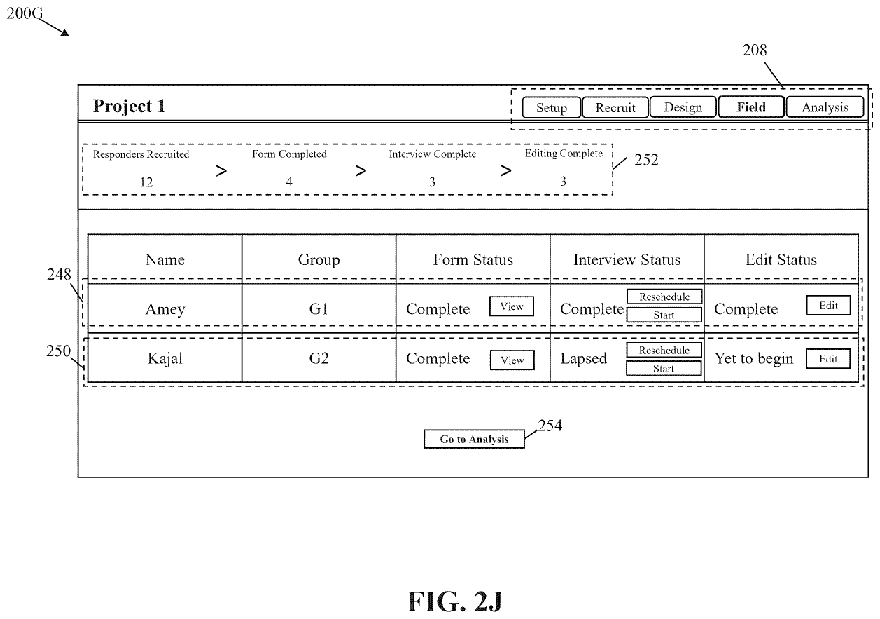

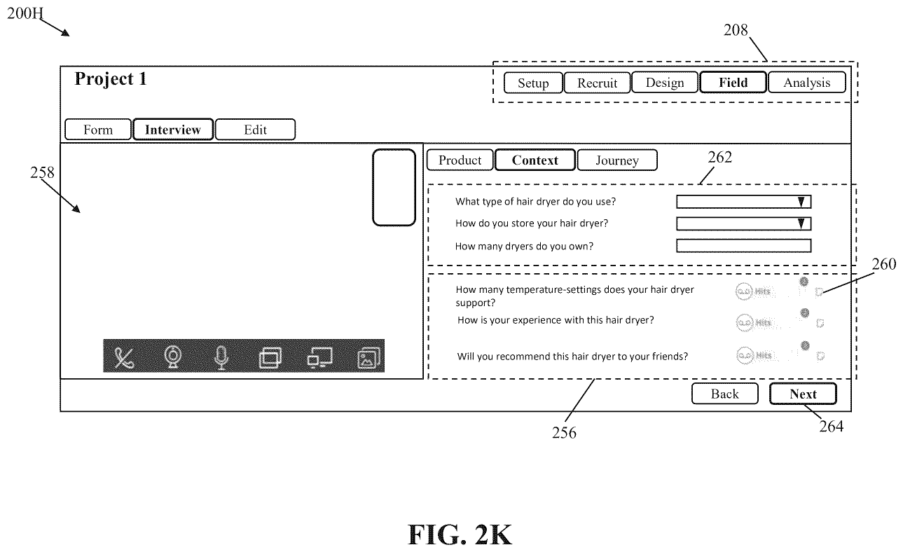

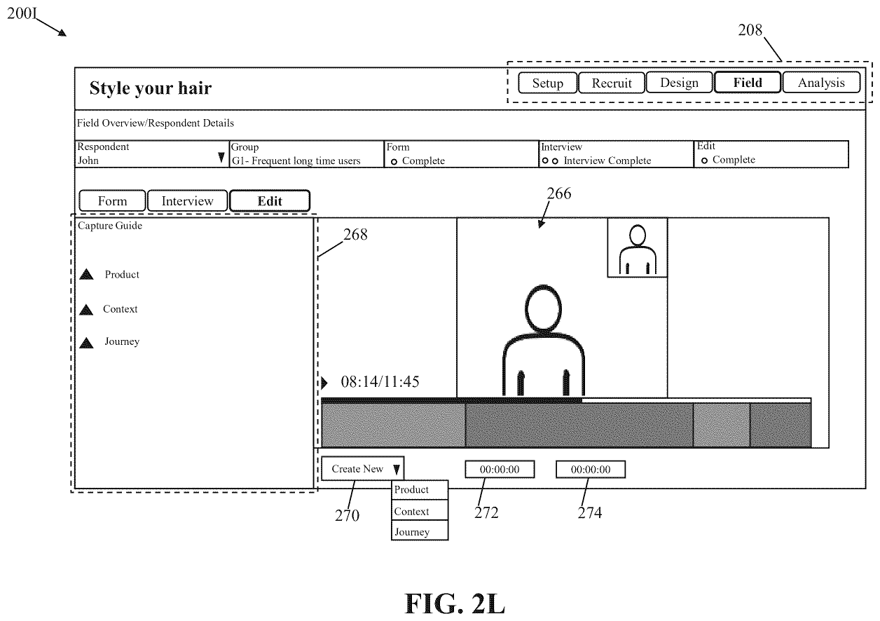

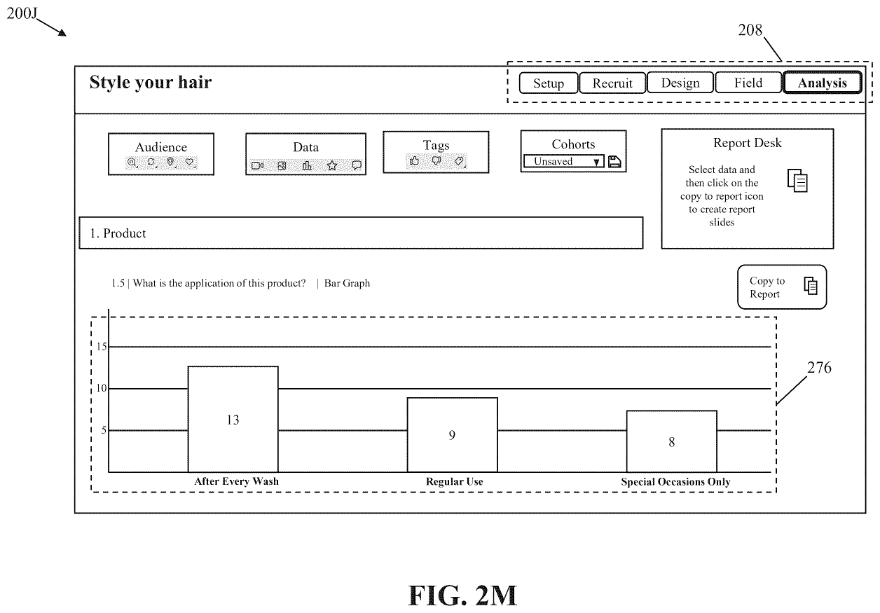

FIGS. 2A-2M are schematic diagrams that illustrate various interface screens of the organizer interface of the service application 108, in accordance with an embodiment of the disclosure.

Referring now to FIG. 2A, shown is a first interface screen 200A that presents a dashboard of the organizer interface. As shown, the first interface screen 200A presents a list (as shown within a first dotted box 202) of ongoing projects and a progress thereof. Each project may have an objective of collecting and tagging relevant multimedia content. For example, ‘Project 1’ may correspond to the collection of multimedia content for relaunching a first hairstyling product. Similarly, ‘Project 2’ may correspond to the collection of multimedia content for the diagnosis of an issue associated with a second hairstyling product. The first interface screen 200A also presents a first selectable option 204 for resuming work on a corresponding project. The first interface screen 200A further presents a second selectable option 206 for creating a new project for the collection and tagging the multimedia content associated with a specific domain (for example, research, survey, diagnosis, relaunch, or the like). A project for multimedia collection and tagging includes a plurality of stages such as a ‘Setup’ stage, a ‘Recruit’ stage, a ‘Design’ stage, a ‘Field’ stage, and an ‘Analysis’ stage.

FIGS. 2B and 2C, collectively, illustrate a second interface screen 200B. Referring now to FIG. 2B, the second interface screen 200B presents the plurality of stages (as shown within a second dotted box 208) for the collection and tagging of the multimedia content. As shown within the second dotted box 208, the ‘Setup’ stage may have been selected by way of the organizer device 112. The ‘Setup’ stage includes a plurality of sub-stages such as a ‘Templates & Team’ sub-stage, a ‘Criteria & Budget’ sub-stage, a ‘Schedule Dates’ sub-stage, and a ‘Publish’ sub-stage. The second interface screen 200B further allows execution of the ‘Templates & Team’ sub-stage. As shown within a third dotted box 210, the ‘Templates & Team’ sub-stage allows the organizer 136 to provide internal as well as public titles or identifiers to the project, a brief description of the project, and eligibility criteria for respondents who may be interested in participating in the project (e.g., interested in answering a survey associated with the project).

Referring now to FIG. 2C, the second interface screen 200B further provides a plurality of templates (as shown within a fourth dotted box 212) that may be selected by the organizer 136 for the creation of a screener questionnaire for the selection of the respondents, a form for textual information to be received from the respondents, and one or more predefined tags for tagging the portions of the multimedia content associated with the project. In some embodiments, as shown within a fifth dotted box 214, each template may include a form part and an interview part. The form part of each template may include a pre-defined questionnaire that is to be filled by the respondents by way of the plurality of user devices 102 for providing textual information for the survey. Further, the interview part of each template may include the plurality of tags and the context corresponding to each tag. For example, each tag may be associated with one or more topics (for example, questions). The form and interview parts may further define corresponding time limits. The content of the form and interview parts may be modified to align with the corresponding project. Further, additional forms or interview parts may be added by the organizer 136 as per the requirement of the project.

The second interface screen 200B may additionally provide a first plurality of selectable options (as shown within a sixth dotted box 216) for the selection of a team that may facilitate online live user interviews with the respondents for the collection of the multimedia content. The team may also access the service application 108 for manually tagging or verifying the tags associated with the portions of the multimedia content. Also, as shown within the sixth dotted box 216, one or more third-party observers may be selected who may observe the progress of the project and may provide inputs from time to time. Subsequently, the second interface screen 200B allows the organizer 136 to initiate execution of the ‘Criteria & Budget’ sub-stage by way of a third selectable option 218.

FIGS. 2D and 2E, collectively, illustrate a third interface screen 200C that facilitates execution of the ‘Criteria & Budget’ sub-stage. Referring now to FIG. 2D, the third interface screen 200C allows the organizer 136 to create a screener questionnaire that may be filled out by the respondents to apply for participation in the project. The third interface screen 200C provides a set of predefined questions (as shown within a seventh dotted box 220) that may be modified to align with eligibility criteria to be met for participating in the project. A screener form filled out by the respondents may be analyzed to determine their eligibility or ineligibility to participate in the project. Referring now to FIG. 2E, the third interface screen 200C allows the organizer 136 to create different user groups (as shown within an eighth dotted box 222) based on one of user experience, work experience, qualification, location, age group, interests, or the like. The respondents selected to participate in the project are categorized into at least one of the user groups.

As shown within a ninth dotted box 224, the third interface screen 200C allows a setting of sample size (e.g., a count of respondents in each group), a type of reward (e.g., cash, coupon, incentives, or the like), amount of each reward, and total budget for getting the forms filled by the respondents. Additionally, as shown within a tenth dotted box 226, the third interface screen 200C allows the organizer 136 to set the sample size, a type of reward, the amount of each reward, and the total budget for the live user interviews with the respondents. Optionally, the third interface screen 200C allows the organizer 136 to select user groups that may fill out the form and participate in the live user interview. The user group selected for filling out the forms may be same or different from the user group selected for participating in the live user interview. Subsequently, as shown within an eleventh dotted box 228, the third interface screen 200C presents the total budget for the form and the live user interview. Further, the third interface screen 200C also provides a fourth selectable option 230 that is selected by the organizer 136 to initiate execution of the ‘Schedule Dates’ sub-stage.

Referring now to FIG. 2F, a fourth interface screen 200D is illustrated. The fourth interface screen 200D enables the organizer 136 to allocate dates and time for establishing a timeline for achieving goals and milestones associated with the project. As shown, the fourth interface screen 200D presents a second plurality of selectable options (as shown within a twelfth dotted box 232) to be selected by the organizer 136 for defining the timeline for the project. For example, the timeline may be scheduled as ‘Pre-field Dates’ for designing the forms and tags and recruiting respondents. Further, the timeline may be scheduled as ‘Field Dates’ for the forms to be filled by the respondents and execution of interactive sessions (i.e., the live user interviews) with the recruited respondents. The timeline for filling out the forms and the execution of the interactive sessions may include a time period selected as ‘Field Dates’ and various timeslots during the time period that may be allocated for the execution of the interactive sessions. Additionally, the timeline may be scheduled as ‘Post-field Dates’ for analysis of the filled forms and the acquired multimedia content. The fourth interface screen 200D further presents a calendar 234 that may be used by the organizer 136 for defining the timeline for different stages of the project. Further, the fourth interface screen 200D presents a detailed calendar 236 for allocating time slots for the execution of the interactive sessions. The fourth interface screen 200D also presents a fifth selectable option 238 for initiating an execution of the ‘Publish’ sub-stage. Throughout the description, the terms ‘video interviews’, ‘interactive sessions’, and ‘live user interviews’ are used interchangeably.

Referring now to FIG. 2G, a fifth interface screen 200E is illustrated. The fifth interface screen 200E presents a summary of different sub-stages of the ‘Setup’ stage. Further, the fifth interface screen 200E presents a sixth selectable option 240 that is selected by the organizer 136 for publishing the project. Upon publication, the project is available on the client interface of the service application 108. Based on the publication of the project, respondents may apply for participating in the project. Upon publication of the project on the client interface of the service application 108, the ‘Recruit’ stage of the project is initiated. For the execution of the ‘Recruit’ stage, one or more respondents are invited or recruited by the organizer 136 for participating in the project based on their answers to the screener questions.

FIG. 2H and FIG. 2I collectively illustrates a sixth interface screen 200F. The sixth interface screen 200F enables the execution of the ‘Design’ stage of the project (as shown within the second dotted box 208). The sixth interface screen 200F has two sections i.e., a ‘Forms’ section and an ‘Interviews’ section (as shown within a thirteenth dotted box 242). The ‘Forms’ section is shown in FIG. 2H within a fourteenth dotted box 244, whereas, the ‘Interviews’ section is shown in FIG. 2I. The ‘Forms’ section allows the organizer 136 to populate the form or template (designed by the administrator 134 via the administrator device 110) with relevant topics or questions to be discussed with or answered by the respondents. In such a scenario, the organizer 136 may choose to retain/modify the questions included in the template. Additionally, the organizer 136 may add a new list of questions in the form in accordance with a requirement of the project. Further, each question may be categorized as per a context thereof. For example, a question regarding a feature of the product may be categorized to be in ‘Section 1’ that may correspond to the ‘Product’ tag and another question pertaining to the ease of use of the product may be categorized in ‘Section 2’ that may correspond to ‘Context’ tag. Hence, upon receiving the answers corresponding to a question in the form, the application server 104 may be configured to tag the answer with a tag associated with the question.

Referring now to FIG. 2I, the ‘Interviews’ section (as shown within the thirteenth dotted box 242) of the sixth interface screen 200F is illustrated. The ‘Interviews’ section enables the organizer 136 to assign a flow to the interactive session and define various subject areas to be discussed during the interactive session (i.e., the live user interview). In other words, the sixth interface screen 200F allows the organizer 136 to define various topics, questions, agendas, or the like for which multimedia content is to be acquired during the interactive session (as shown within a fifteenth dotted box 246). Further, each topic, question, agenda, or the like may be associated with a tag and a portion of the multimedia content.

Each template may have default topics, questions, agendas, or the like, which is associated with default tags. Such default topics, questions, agendas, or the like, and associated tags may be modified by the organizer 136 as per a requirement of the project. For example, a project may pertain to a survey regarding the relaunch of a product ‘Hairdryer’. A first topic to be discussed during an interactive session may be ‘What product type do you use?’. The first topic may be associated with a ‘Product’ tag. A second topic to be discussed during the interactive session may be ‘How do you store your product?’. The second topic may be associated with a ‘Context’ tag. Similarly, the organizer 136 may design/modify the template to include various topics that need to be discussed during the interactive sessions and corresponding tags. In some embodiments, a tag may be associated with multiple questions. For example, the ‘Product’ tag may be additionally associated with questions such as ‘Which brand of hair dryer do you use’ and ‘Could you please show your hair dryer?’. Hence, multimedia content corresponding to both questions may be tagged with the ‘Product’ tag.

Upon completion of the ‘Design’ stage, the ‘Field’ stage is initiated. Referring now to FIG. 2J, shown is a seventh interface screen 200G that enables the organizer 136 to view a list of respondents recruited for participating in the project. Further, the seventh interface screen 200G presents the form status as well as the interview status of each participant. For example, as shown within a sixteenth dotted box 248, a respondent named ‘Amey’, who belongs to a user group ‘G1’, has filled out the form and completed the interactive session (i.e., the live user interview). Therefore, the status of participation of the participant ‘Amey’ may be ‘Complete’. Similarly, as shown within a seventeenth dotted box 250, a participant named ‘Kajal’, who belongs to a user group ‘G2’, has not filled out the form and a schedule for participating in the interactive session has lapsed, and hence, the interview may have to be rescheduled. Therefore, the status of participation of the participant ‘Kajal’ may be ‘Yet to begin’. Additionally, as shown within the sixteenth and seventeenth dotted boxes 248 and 250, respectively, the seventh interface screen 200G enables the organizer 136 to edit the interview of the corresponding participant, for example, the participant ‘Amey’. While editing the interview, the organizer 136 may insert or modify tags within the multimedia content of the live user interview. Such tags may be inserted after the multimedia content of the live user interview has already been recorded, and may be defined dynamically.

As shown within an eighteenth dotted box 252, the seventh interface screen 200G further presents a summary of the ‘Field’ stage of the project. As shown, a count of respondents recruited for participating in the project is ‘12’, a count of forms filled by the respondents is ‘4’, a count of interviews completed by the respondents is ‘3’, and a count of recordings that are edited is ‘3’. The ‘Field’ stage is considered to be complete when the count of forms filled by the respondents, the count of interviews completed by the respondents, and the count of edited interviews are equal to the count of respondents recruited for participating in the project, e.g., ‘12’. Upon completion of the ‘Field’ stage, the ‘Analysis’ stage of the project is initiated by way of a seventh selectable option 254. In some embodiments, the completion of the project is decided by the organizer 136. In such cases, the seventh selectable option 254 is selected by the organizer 136 to complete the project. In some embodiments, the project is deemed to be completed once a schedule allocated to the project expires.

Referring now to FIG. 2K, illustrated is an eighth interface screen 200H associated with the ‘Field’ stage of the project. The eighth interface screen 200H may be used during the interactive session. During the interactive session, a microphone of the first user device 102a may be used for recording the voice of the first respondent 128 and a camera of the first user device 102a may be used for recording a visual image of the respondent. The live user interview may proceed in a sequence defined by the template. The application server 104 may record the interactive session. The recording of the interactive session may be initiated by the organizer 136 by way of the organizer device 112 (e.g., by selecting a ‘Begin interview’ option (not shown)). The application server 104 may initiate recording a discussion on a first topic based on pressing of a corresponding record button. The record button associated with the first topic may be a context indicator thereof. In an example, shown within a nineteenth dotted box 256, each question has a corresponding record button that when pressed may act as the context indicator. Hence, the multimedia clip subsequently generated may get tagged with one or more tags indicated by the context indicator. Further, as shown within the nineteenth dotted box 256, the eighth interface screen 200H may include various record buttons and tags associated therewith. Each pair of the record button and the tag is linked to one topic. For example, a first question ‘How many temperature settings does your hair dryer support?’ may have a corresponding record button and a ‘Product’ tag. Therefore, once the first respondent 128 starts to answer the first question, a first use of the record button (e.g., context indicator) may indicate the start of the portion that is to be tagged with the ‘Product’ tag. When the first respondent 128 finishes the answer, a second use of the record button may indicate the end of the portion that is to be tagged with the ‘Product’ tag. In addition to the pre-defined tags, the eighth interface screen 200H may further provide an option (for example, an input field 260) for the organizer 136 to add labels to each portion of the multimedia content.

As shown, during the interactive session, the organizer 136 is presented with a display area 258 that may present a visual image of the first respondent 128 and a visual image of the organizer 136 during the interactive session. The visual image of the first respondent 128 is presented such that a majority portion of the display area 258 is covered. On the other hand, the visual image of the organizer 136 is placed in the top-right corner of the visual image of the first respondent 128. Further, the organizer 136 may select a third plurality of selectable options (shown within a twentieth dotted box 262) for acquiring information/answers corresponding to various topics/questions being discussed during the live user interview. The first respondent 128 may provide the information/answers corresponding to various topics/questions being discussed during the live user interview. The organizer 136 may note the responses via one or more options (for example, a dropdown menu, a radio button, a text box, etc.) corresponding to each topic/question.

Although FIG. 2K illustrates dropdown menus and text boxes available for providing information/answer to various topics/questions being discussed during the live user interview, the scope of the disclosure is not limited to it. In other embodiments, the information/answers may be noted by any other means (for example, a text input, a graphical input, or the like).

To summarize, for each topic, question, agenda, or the like, the organizer 136 may input the first alert (for example, the first use of the record button) indicative of a start of a discussion and the second alert (for example, the second use of the record button) indicative of an end of a discussion via the organizer device 112. Based on the received first and second alerts, the application server 104 may tag a portion of the multimedia content, recorded during a time period between the reception of the start and end alerts, with a tag associated with the question, topic, agenda, or the like, being discussed by the respondent during the time period. Once the interactive session is complete, the organizer 136 may access an eighth selectable option 264 to proceed to the editing of the recorded multimedia content.

Referring now to FIG. 2L, illustrated is a ninth interface screen 200I for editing the recorded multimedia content. The ninth interface screen 200I may be used by the organizer 136 to manually insert one or more tags and labels to untagged portions of the recorded multimedia content or modify existing tags and labels. Labels may include text, symbol, or identifier that is indicative of a context of a corresponding multimedia clip. As shown, the recorded multimedia content (e.g., multimedia clips generated by the application server 104 immediately after the recording is concluded) is presented via a media section 266. The multimedia clips associated with one tag are stored at the storage location in the database server 106 or the memory 124 that is associated with the corresponding tag. For example, the multimedia clips related to the ‘Product’ tag are stored at a storage location in the database server 106 or the memory 124 that is associated with the ‘Product’ tag. The ‘Product’ tag may have one or more questions, topics, or the like associated therewith. Therefore, one or more multimedia clips associated with each question having the ‘Product’ tag are stored in the storage location in the database server 106 or the memory 124 that is in association with the ‘Product’ tag. Various tags are shown in an ‘Edit’ portion (shown within a twenty-first dotted box 268) of the ninth interface screen 200I. Further, the application server 104 may assign tags to the untagged portions of the multimedia content based on the input of the organizer (e.g., the organizer 136 may select a tag from a pull-down menu shown within a twenty-second dotted box 270). Similarly, start and end points for a multimedia clip are provided by inputting time instances in a start field 272 and an end field 274.

Although it is described that the interactive session is conducted by the organizer 136, the scope of the present disclosure is not limited to it. In some embodiments, the interactive session is conducted by a member of the team associated with the project, without deviating from the scope of the present disclosure.

Upon completion of the ‘Field’ stage, the ‘Analysis’ stage of the project may be accessed by way of a tenth interface screen 200J illustrated in FIG. 2M. The tenth interface screen 200J provides insights (as shown within a twenty-third dotted box 276) based on the forms filled by the respondents of the project and the multimedia content associated with the live user interviews of the respondents of the project. The insights are sorted or filtered based on various factors such as demographic details, geographical location, product type, and the like. Further, the tenth interface screen 200J also allows the service application 108 to present different views of the analysis based on images and graphs. Additionally, for multimedia clips associated with each tag, a collation of associated multimedia clips is provided.

It will be apparent to a person skilled in the art that FIGS. 2A-2M corresponds to an embodiment where the start and end alerts are provided manually via the organizer device 112 however the disclosure is not limited to it. In other embodiments, the start and the end alerts may be determined differently, for example, based on a detection of a keyword, expression, gesture or the like that may be indicative of a portion of the multimedia content that is to be tagged.

It will be apparent to a person of skill in the art that the interface screens illustrated in FIGS. 2A-2M are exemplary and do not limit the scope of the disclosure.

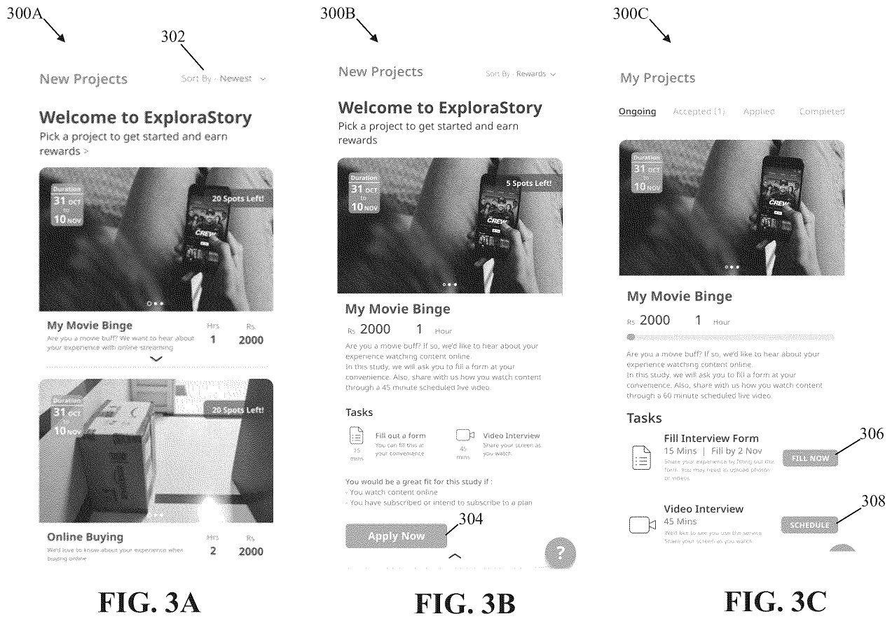

FIGS. 3A-3C are schematic diagrams that illustrate various interface screens of the client interface of the service application 108, in accordance with an embodiment of the disclosure.

Referring now to FIG. 3A, illustrated is an eleventh interface screen 300A that presents a homepage of the client interface of the service application 108. As shown, the eleventh interface screen 300A presents a plurality of ongoing projects in which the first respondent 128 may participate based on their eligibility. As shown by way of a ninth selectable option 302, the first respondent 128 may view the projects sorted in accordance with a publication date, a type of project, or the like. Upon selecting a given project, the first respondent 128 is presented with information associated with the selected project.

Referring now to FIG. 3B, the first respondent 128 may have selected a project ‘My Movie Binge’. Subsequently, a twelfth interface screen 300B is presented to the first respondent 128 presenting details associated with the project ‘My Movie Binge’. Details of the project ‘My Movie Binge’ may include a brief about the project, tasks to be performed while participating in the project, a reward amount, a reward type, a time period to be allocated for the project, or the like. Further, the twelfth interface screen 300B provides a tenth selectable option 304 that is used by the first respondent 128 to apply for participation in the project.

Referring now to FIG. 3C, upon their recruitment, the first respondent 128 is presented with a thirteenth interface screen 300C that presents the first respondent 128 with their profile information including a count and detail of projects in which the first respondent 128 has been recruited, details of the projects in which the first respondent 128 has applied, details of projects which the first respondent 128 has already completed, or the like. Further, the thirteenth interface screen 300C presents the respondent with eleventh and twelfth selectable options 306 and 308 that is selected by the first respondent 128 for completing the tasks, i.e., filling out the form and scheduling the interview, respectively. Once the first respondent 128 selects the eleventh selectable option 306, the thirteenth interface screen 300C gets directed to a form associated with the project ‘My Movie Binge’. Upon selection of the twelfth selectable option 308, the thirteenth interface screen 300C gets directed to a page where a scheduled timeslot for participating in the live user interview is selected. The first respondent 128 may get interviewed via a video call. Once the tasks associated with the project are completed by the first respondent 128, the reward is provided to the first respondent 128 in a suitable or selected manner (e.g., cash, coupon, or the like).

It will be apparent to a person of skill in the art that the interface screens illustrated in FIGS. 3A-3C are exemplary and does not limit the scope of the disclosure.

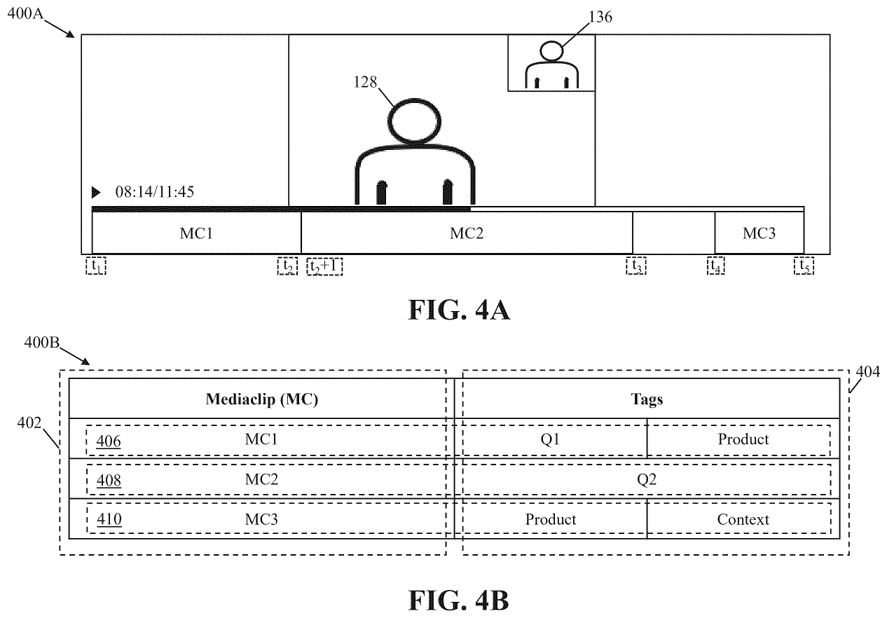

FIGS. 4A and 4B, collectively, illustrate an exemplary scenario for tagging the multimedia content, in accordance with an embodiment of the disclosure.

Referring to FIG. 4A, shown is a schematic diagram 400A that shows a live user interview being recorded for gathering information regarding user review of a hair dryer. The live user interview is conducted by the organizer 136, and the first respondent 128 may participate in the live user interview in order to provide his/her user review. The organizer 136 may discuss the respondent's experience with the hair dryer during the live user interview. Hence, an objective of the live user interview is to collect information regarding the review of the hair dryer from the first respondent 128.

During the live user interview, the first respondent 128 may discuss a plurality of topics and may answer a plurality of questions associated with the hair dryer. Each topic and question are associated with at least one tag from a plurality of tags pertaining to the review of the hair dryer. The plurality of tags may include: ‘product’, ‘context’, ‘Q1’, and ‘Q2’. The tag Q1 may be indicative of a context of a first question ‘What is the application of the product?’. The tag Q2 may be indicative of a context of a second question ‘How many users use this product?’. The plurality of tags is provided by the organizer 136 via the organizer device 112 prior to the live user interview. The plurality of tags is associated with a domain of the live user interview pertaining to the review of the hair dryer. In a first example, the domain of the live user interview is ‘user experience of a hair dryer’. In such an example, the plurality of tags may include ‘Brand’, ‘Product’, ‘Context’, ‘Ease of use’, ‘wear and tear’, ‘aging’, or the like. In a second example, the domain of the live user interview is ‘Relaunch of a hair dryer’. In such an example, the plurality of tags may include ‘Brand’, ‘user experience’, ‘Type of product’, ‘Recommendation’, and the like. As evident in the first and second examples, the plurality of tags is indicative of at least one of a subject, an objective, or a keyword associated with the domain of the live user interview.

In an embodiment, a topic being discussed in the live user interview may be ‘a movie’. In such an embodiment, a tag associated with a corresponding multimedia clip may be ‘Movie’ that may be a subject of discussion of the live user interview. In another embodiment, a topic being discussed in the live user interview may be ‘urban lifestyle’. In such an embodiment, a tag associated with a corresponding multimedia clip is ‘urban’ which is a frequently used keyword during the live user interview.

In some embodiments, the application server 104 may be configured to update the plurality of tags based on an input received via the organizer device 112 of the organizer 136. The plurality of tags may be updated as a result of a change in one of the objective, the subject, the domain, or the like of the user interview. In some embodiments, the plurality of tags may be updated to include or exclude one or more tags based on a requirement thereof for tagging the multimedia content. Referring to the first example, the objective of the live user interview may have changed from ‘user experience of a hair dryer’ to ‘user experience of hair dryer of brand ABC’. Hence, the plurality of tags is updated to exclude the tag ‘Brand’ from the plurality of tags. Referring to the second example, the plurality of tags is updated to modify the tag ‘Which brand of dryer do you use?’ to ‘Which hair styling electronic product do you use?’. In some embodiments, the plurality of tags may be updated due to the change in the subject of the live user interview. For example, a first subject of the live user interview may have been ‘Movie Review’ and the plurality of tags may have included ‘Genre’, ‘Rating’, ‘Songs’, or the like. However, the first subject ‘Movie Review’ may have changed to a second subject ‘Daily Soap Review’. Hence, the plurality of tags is updated to include ‘Weekly’, ‘Daily’, ‘Family Drama’, ‘Storyline’, ‘Target User’, and the like. In some embodiments, the plurality of tags is updated due to the change in the domain of the live user interview. For example, a first domain associated with the live user interview may be ‘clinical trial of a first drug’ and the plurality of tags may include ‘Stage of clinical trial’, ‘Drug Name’, ‘Composition’, ‘Size of clinical trial’, and the like. Later, the domain of the clinical trial may have changed to ‘review of the first drug’. Therefore, the plurality of tags may include ‘Effect’, ‘Side Effects’, ‘Cost’, ‘Recommendation’, and the like.

During the live user interview, the organizer 136 may ask the first respondent 128 to describe one or more features of the hair dryer being reviewed. The first time instance may be one of (i) an instance when the organizer 136 may have started to ask for the description, (ii) an instance when the organizer 136 may have finished asking for the description, and (iii) an instance when the first respondent 128 may have initiated the description. In an embodiment, the first alert is determined based on the presence of the trigger in the multimedia content. In such an embodiment, the organizer 136, before asking a question or initiating a topic, may wave his/her hand based on which the application server 104 may determine the first alert. Alternatively, the first respondent 128 may nod his/her head before answering a question or initiating a topic. In some embodiments, the organizer 136 or the first respondent 128 may blink twice before asking/answering a question or initiating a topic.

As shown in FIG. 4A, the first alert may be determined at a first time instance t₁. For the sake of brevity, it is assumed that the start of the portion of the multimedia content to be tagged is at the first time instance t₁. The first alert determined at the first time instance t₁ is indicative of the start of a first portion of the multimedia content that is to be tagged. Subsequently, at a second time instance t₂, the application server 104 may detect the second alert that is indicative of an end of the first portion. Once the start and the end of the first portion are determined, the application server 104 may generate a first multimedia clip ‘MC1’. The first multimedia clip ‘MC1’ is generated while the live user interview is being recorded or once the recording of the live user interview gets concluded.

Subsequently, the application server 104 is configured to identify a tag to be linked to the first multimedia clip ‘MC1’. The application server 104 may identify the tag based on a context of the first multimedia clip ‘MC1’. The context of the first multimedia clip ‘MC1’ is determined based on one or more (predefined or dynamic) keywords detected in the first multimedia clip ‘MC1’. In some embodiments, the context of the first multimedia clip ‘MC1’ is determined based on one or more synonyms of the predefined keywords detected in the first multimedia clip ‘MC1’. In an example, the first multimedia clip ‘MC1’ may have words ‘hair styling electronic product’ and ‘blow dry’. The application server 104 may detect that the word ‘hair styling electronic product’ is a synonym to a predefined word ‘Hair dryer’. Based on such detection, the application server 104 may detect the context of the first multimedia clip ‘MC1’ to be a description of the hair dryer being reviewed. Hence, the application server 104 may identify and link the tag ‘Product’ with the first multimedia clip ‘MC1’. The application server 104 may further identify that the first multimedia clip ‘MC1’ also includes content regarding the application of the hair dryer being reviewed. Therefore, the application server 104 may identify the tag ‘Q1’ to be indicative of the context of the first multimedia clip ‘MC1’. The tag ‘Q1’ is associated with the question ‘What is the application of the product?’. Hence, the application server 104 may link the tag ‘Q1’ with the first multimedia clip ‘MC1’. Subsequently, the application server 104 may store the first multimedia clip ‘MC1’ and the tags ‘Product’ and ‘Q1’ linked thereto in at least one of the database server 106 and the memory 124.

In some embodiments, one or more tags indicative of a context of the first multimedia clip ‘MC1’ may not be included in the plurality of tags. In such embodiments, the application server 104 is configured to receive a new tag as an input via the organizer device 112. In other words, a new tag that is indicative of the context of the first multimedia clip ‘MC1’ is provided by the organizer 136 by way of the organizer device 112. Subsequently, the application server 104 may link the received new tag to the first multimedia clip ‘MC1’ and store the first multimedia clip ‘MC1’ and corresponding tags ‘Products’, ‘Q1’, and the new tag in the memory 124 or the database server 106.

Further, as shown in FIG. 4A, at a third time instance t₂+1, a start of a second multimedia clip ‘MC2’ is determined as described with respect to the first multimedia clip ‘MC1’. Subsequently, the application server 104 may determine, at a fourth time instance t₃, an end of the second multimedia clip ‘MC2’. Further, the application server 104 may determine a context of the second multimedia clip ‘MC2’ that contains a question ‘How many people use the product?’ being asked by the organizer 136 and/or being answered by the first respondent 128 being interviewed. Subsequently, the application server 104 may link the tag ‘Q2’ to the second multimedia clip ‘MC2’. The tag ‘Q2’ is indicative of a context of an answer to the question ‘How many people use the product?’. The application server 104 may update the memory 124 or the database server 106 to store the second multimedia clip ‘MC2’ and the corresponding tag ‘Q2’.

During a time period between the fourth time instance t₃ and a fifth time instance t₄, the application server 104 may not detect a multimedia clip that should be tagged. At the fifth time instance t₄, the application server 104 may detect a start of a third multimedia clip ‘MC3’. The application server 104 may further determine, at a sixth time instance t₃, an end of the third multimedia clip ‘MC3’. Subsequently, the application server 104 may determine a context of the third multimedia clip ‘MC3’. Based on the determined context of the third multimedia clip ‘MC3’, the application server 104 may link the third multimedia clip ‘MC3’ with the tag ‘Product’ and the tag ‘context’. As shown, the tag ‘Product’ is linked to the first multimedia clip ‘MC1’ as well as the third multimedia clip ‘MC3’.

Referring now to FIG. 4B, illustrated is a record (for example, a table 400B) maintained in the database server 106 and/or the memory 124 for storing the multimedia clips and corresponding tags, in accordance with an embodiment of the disclosure. The table 400B includes two columns i.e., a first column (shown within a twenty-fourth dotted box 402) including entries of multimedia clips and a second column (shown within a twenty-fifth dotted box 404) including entries of tags corresponding to the multimedia clips in the first column. A first row (shown within a twenty-sixth dotted box 406) of the table 400B includes a record of the first multimedia clip ‘MC1’. A first cell of the first column includes an entry of the first multimedia clip ‘MC1’ and a first cell of the second column includes entries of tags i.e., the tag ‘Q1’ and the tag ‘Product’ linked to the first multimedia clip ‘MC1’. Similarly, a second row (shown within a twenty-seventh dotted box 408) of the table 400B includes a record of the second multimedia clip ‘MC2’ and the tag ‘Q2’ linked to the second multimedia clip ‘MC2’. The third row (shown within a twenty-eighth dotted box 410) of the table 400B includes a record of the third multimedia clip ‘MC3’ and the tag ‘Product’ and the tag ‘Context’ linked to the third multimedia clip ‘MC3’. The table 400B is updated by the application server 104 to reflect most recent and correct tagging of the multimedia content.

In some embodiments, once the multimedia clips included in the multimedia content are tagged, the application server 104 may perform the analysis of the multimedia clips and corresponding tags. In other words, the application server 104 may perform an analysis of the first multimedia clip ‘MC1’ and the corresponding tag ‘Q1’ and tag ‘Product’, the second multimedia clip ‘MC2’ and the corresponding tag ‘Q2’, and third multimedia clip ‘MC3’ and the corresponding tags ‘Product’ and ‘Context’. Based on the analysis, the application server 104 may present one or more insights to the organizer 136 via the organizer device 112.

It will be apparent to a person skilled in the art that FIGS. 4A and 4B are exemplary and do not limit the scope of the disclosure.

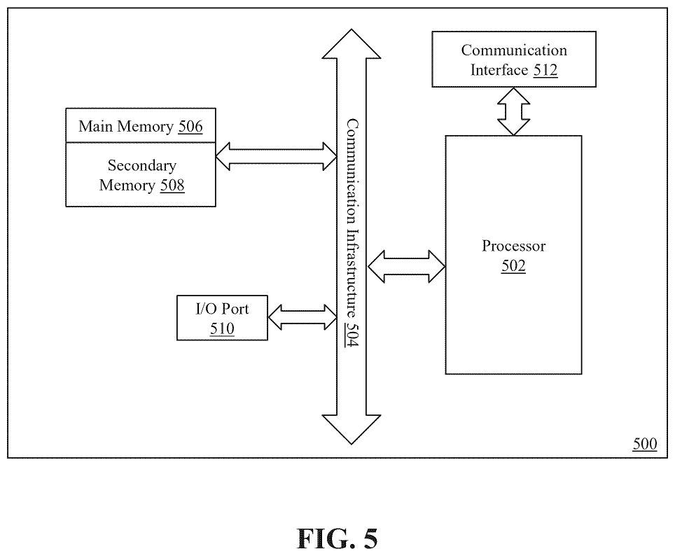

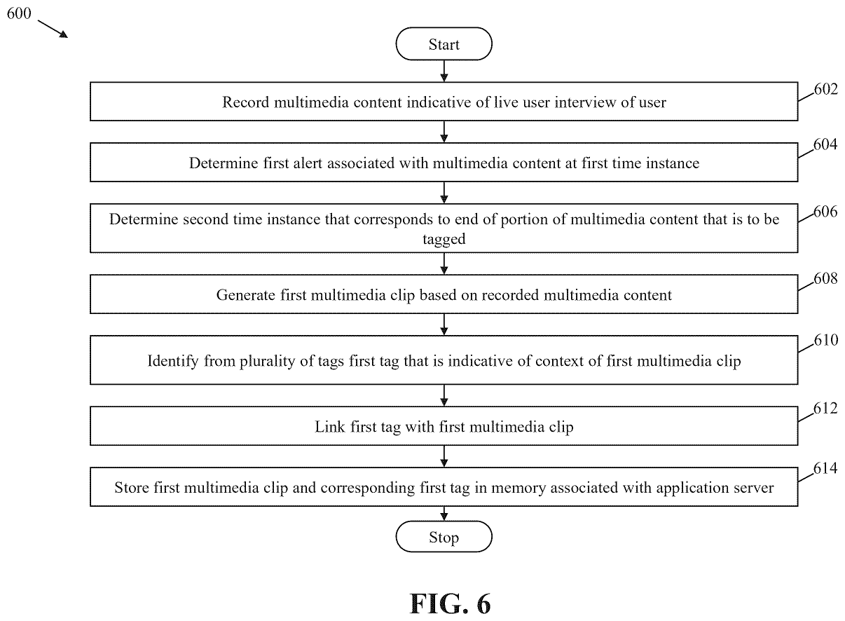

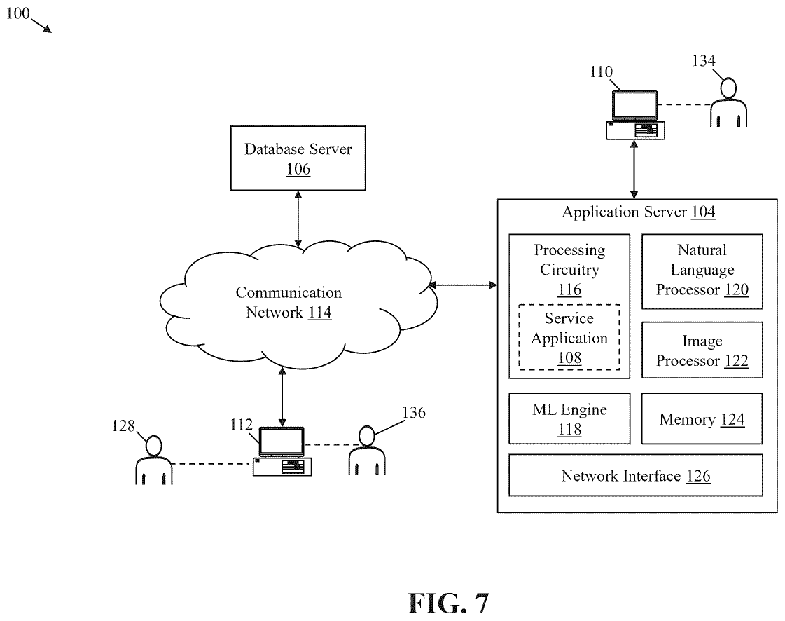

FIG. 5 is a block diagram that illustrates a system application of a computer system 500 for tagging the multimedia content, in accordance with an embodiment of the disclosure. An embodiment of the disclosure, or portions thereof, may be implemented as computer-readable code on the computer system 500. In one example, the application server 104 or the database server 106 of FIG. 1 may be implemented in the computer system 500 using hardware, software, firmware, non-transitory computer-readable media having instructions stored thereon, or a combination thereof and may be implemented in one or more computer systems or other processing systems. Hardware, software, or any combination thereof may embody modules and components used to implement the method of FIG. 6.

The computer system 500 may include a processor 502 that may be a special-purpose or a general-purpose processing device. The processor 502 may be a single processor or multiple processors. The processor 502 may have one or more processor cores. Further, the processor 502 may be coupled to a communication infrastructure 504, such as a bus, a bridge, a message queue, the communication network 114, a multi-core message-passing scheme, or the like. The computer system 500 may further include a main memory 506 and a secondary memory 508. Examples of the main memory 506 may include random-access memory (RAM), a read-only memory (ROM), or the like. The secondary memory 508 may include a hard disk drive or a removable storage drive, such as a floppy disk drive, a magnetic tape drive, a compact disc, an optical disk drive, a flash memory, or the like. Further, the removable storage drive may read from and/or write to a removable storage device in a manner known in the art. In an embodiment, the removable storage unit may be a non-transitory computer-readable recording media.

The computer system 500 may further include an input/output (I/O) port 510 and a communication interface 512. The I/O port 510 may include various input and output devices that are configured to communicate with the processor 502. Examples of the input devices may include a keyboard, a mouse, a joystick, a touchscreen, a microphone, and the like. Examples of the output devices may include a display screen, a speaker, headphones, and the like. The communication interface 512 may be configured to allow data to be transferred between the computer system 500 and various devices that are communicatively coupled to the computer system 500. Examples of the communication interface 512 may include a modem, a network interface, i.e., an Ethernet card, a communication port, and the like. Data transferred via the communication interface 512 may be signals, such as electronic, electromagnetic, optical, or other signals as will be apparent to a person skilled in the art. The signals may travel via a communications channel, such as the communication network 114, which may be configured to transmit the signals to the various devices that are communicatively coupled to the computer system 500. Examples of the communication channel may include a wired, wireless, and/or optical media such as cable, fiber optics, a phone line, a cellular phone link, a radio frequency link, and the like. The main memory 506 and the secondary memory 508 may refer to non-transitory computer-readable mediums that may provide data that enables the computer system 500 to implement the method illustrated in FIG. 6.

FIG. 6 is a flowchart 600 that illustrates a method for tagging the multimedia content, in accordance with an embodiment of the disclosure. The organizer 136 may initiate the interactive session. At 602, the multimedia content that is indicative of the live user interview of the user (e.g., the first respondent 128) is recorded. The application server 104 is configured to record the multimedia content that includes the live user interview of the first respondent 128.

At 604, the first alert associated with the multimedia content is determined at the first time instance. The application server 104 is configured to determine the first alert associated with the multimedia content. The first alert is indicative of the start of the portion of the multimedia content that is to be tagged.

At 606, the second time instance that corresponds to the end of the portion of the multimedia content that is to be tagged is determined. The application server 104 is configured to determine the second time instance that corresponds to the end of the portion of the multimedia content that is to be tagged.

At 608, the first multimedia clip is generated based on the multimedia content. The application server 104 is configured to generate the first multimedia clip based on the multimedia content. The first multimedia clip includes the portion of the multimedia content that is to be tagged.

At 610, the first tag that is indicative of the context of the first multimedia clip is identified from the plurality of tags. The application server 104 is configured to identify, from the plurality of tags, based on the first alert, the first tag that is indicative of the context of the first multimedia clip.

At 612, the first tag is linked with the first multimedia clip. The application server 104 is configured to link the first tag with the first multimedia clip.

At 614, the first multimedia clip and the corresponding first tag are stored in the memory 124 associated with the application server 104. The application server 104 is configured to store the first multimedia clip and the corresponding first tag in the memory 124 associated with the application server 104.

It will be apparent to a person of skill in the art that the method illustrated in FIG. 6 is exemplary and does not limit the scope of the disclosure.

FIG. 7 is a block diagram that illustrates the system environment 100 for tagging the multimedia content, in accordance with another embodiment of the disclosure. As shown in FIG. 7, the system environment 100 includes the application server 104, the database server 106, the administrator device 110, the organizer device 112, and the communication network 114. The operations being performed by each component remain same as described throughout the disclosure. The difference between the system environment 100 of FIGS. 1 and 7 is that the system environment 100 of FIG. 7 is sans the plurality of user devices (e.g., the first through third user devices 102a-102c). Thus, the application server 104 may be configured to record the multimedia content via the organizer device 112. In other words, the first respondent 128 and the organizer 136 may be present at the same location and the organizer 136 may conduct an interview of the first respondent 128 via the organizer device 112.

The disclosed embodiments encompass numerous advantages. Exemplary advantages of the disclosed methods include, but are not limited to, seamless and accurate tagging of portions of the multimedia content. The disclosed methods and systems enable easy and quick access to a desired portion of the multimedia content. Further, the tags associated with the portions of the multimedia content are indicative of the context of the corresponding portion. Hence, such tagging of the multimedia content reduces the requirement of manually accessing the multimedia content for retrieving relevant information, thereby increasing the effectiveness and accuracy of the survey, interview, or the like. Further, such tagging saves a significant amount of time by indicating the context of the multimedia content as users do not require to access irrelevant or random multimedia content. As a result, the multimedia content tagging method of the present disclosure is scalable and efficient in cases where a significant number of interviews are to be conducted.

Certain embodiments of the disclosure may be found in the disclosed systems, methods, and non-transitory computer-readable medium, for multimedia content tagging. Exemplary aspects of the disclosure provide the methods and the systems for tagging portions of the multimedia content. The methods and systems include various operations that are executed by a server (for example, the application server 104, a processor, or the like). In an embodiment, the application server 104 is configured to record the multimedia content that is indicative of the live user interview of the first respondent 128. The application server 104 is further configured to determine the first alert associated with the multimedia content at the first time instance. The first alert is indicative of the start of the portion of the multimedia content that is to be tagged. The application server 104 is further configured to determine the second time instance that corresponds to the end of the portion of the multimedia content that is to be tagged. The application server 104 is further configured to generate the first multimedia clip based on the multimedia content. The first multimedia clip includes the portion of the multimedia content that is to be tagged. The application server 104 is further configured to identify, from the plurality of tags, the first tag that is indicative of the context of the first multimedia clip. The application server 104 is further configured to link the first tag with the first multimedia clip. The application server 104 is further configured to store the first multimedia clip and the corresponding first tag in the memory 124 associated with the application server 104.

In some embodiments, a non-transitory computer-readable medium is provided that is encoded with processor executable instructions that when executed by the processor perform the steps of the method for tagging multimedia content.

In some embodiments, the first alert is determined based on the detection of the trigger in the live user interview. The trigger includes at least one of a gesture, a facial expression, and one or more predefined keywords associated with the first respondent 128 in the live user interview.

In some embodiments, the first alert corresponds to the input received via the organizer device 112 of the organizer 136 of the live user interview.

In some embodiments, the start of the portion of the multimedia content that is to be tagged is at the gap of the predefined time interval from the first time instance.

In some embodiments, the application server 104 is further configured to receive, via the organizer device 112 of the organizer 136 of the live user interview, the second alert associated with the multimedia content at the second time instance. The second alert is indicative of the end of the portion of the multimedia content that is to be tagged. The second time instance is determined by the application server 104 based on the reception of the second alert.

In some embodiments, the first and second alerts are received while the multimedia content is being recorded.

In some embodiments, the second time instance is determined by the application server 104 to be at the predefined time duration after the first time instance.

In some embodiments, the application server 104 is configured to identify, from the plurality of tags, the second tag that is indicative of the context of the first multimedia clip. The application server 104 is further configured to link the second tag with the first multimedia clip. The application server 104 is further configured to store the first multimedia clip and the corresponding second tag in the memory 124 associated with the application server 104.

In some embodiments, the application server 104 is configured to store the plurality of tags, in the memory 124. Each tag of the plurality of tags is indicative of at least one context associated with the multimedia content. The application server 104 is further configured to receive, via the organizer device 112 of the organizer 136 of the live user interview, the context indicator that is indicative of the context of the portion of the multimedia content to be tagged. The first tag is identified from the plurality of tags based on the context indicator.

In some embodiments, the application server 104 is configured to receive the second tag via the organizer device 112 of the organizer 136 of the live user interview for the first multimedia clip. The application server 104 is further configured to link the second tag with the first multimedia clip. The application server 104 is further configured to store the first multimedia clip and the corresponding second tag in the memory 124 associated with the application server 104.

In some embodiments, the application server 104 is configured to receive, after the first alert, the label via the organizer device 112 of the organizer 136 of the live user interview. The label corresponds to one or more characteristics, that are different from the first tag, assigned to the portion of the multimedia content that is to be tagged. The application server 104 is further configured to link the label with the first multimedia clip. The application server 104 is further configured to store the label in the memory 124 associated with the application server 104 in conjunction with the first multimedia clip and the first tag.

In some embodiments, the application server 104 is further configured to receive, via the organizer device 112 of the organizer 136 of the live user interview, the input indicative of the instruction to delink the first tag from the first multimedia clip. The application server 104 is configured to update the first multimedia clip and the corresponding first tag stored in the memory 124 to delink the first tag from the first multimedia clip.

In some embodiments, the application server 104 is further configured to receive, via the organizer device 112 of the organizer 136 of the live user interview, the input indicative of the instruction to delink the first tag from the first multimedia clip and link the second tag to the first multimedia clip. The application server 104 is further configured to update the first multimedia clip and the corresponding first tag stored in the memory 124 to delink the first tag from the first multimedia clip. The application server 104 is further configured to link the second tag with the first multimedia clip. The application server 104 is further configured to store the first multimedia clip and the corresponding second tag in the memory 124.

In some embodiments, the application server 104 is further configured to present on the organizer device 112 of the organizer 136 of the live user interview, the multimedia content having the first multimedia clip and the first tag. The application server 104 is further configured to receive, via the organizer device 112, the input that verifies the first tag and the start and the end of the first multimedia clip.

In some embodiments, the application server 104 is further configured to receive, over the communication network 114, the multimedia content from the user device (for example, the first user device 102a) of the user during the live user interview. The live user interview is conducted for gathering user information regarding a domain of the live user interview from the first respondent 128. The received multimedia content is recorded to enable the tagging of the multimedia content.

In some embodiments, the application server 104 is further configured to receive, over the communication network 114, the multimedia content from the organizer device 112 of the organizer 136 of the live user interview. The live user interview is conducted for gathering user information regarding the domain of the live user interview from the user. The received multimedia content is recorded to enable the tagging of the multimedia content.

In some embodiments, the application server 104 is further configured to receive, via the organizer device 112 of the organizer 136 of the live user interview, the domain of the live user interview, and the plurality of tags associated with the domain. Each tag of the plurality of tags is indicative of at least one of a subject, an objective, or a keyword associated with the domain of the live user interview.

In some embodiments, the application server 104 is further configured to generate the second multimedia clip that includes the portion of the multimedia content corresponding to the time interval between the third time instance and the fourth time instance. The application server 104 is further configured to identify, from the plurality of tags, the second tag that is indicative of the context of the second multimedia clip. The application server 104 is further configured to link the second tag with the second multimedia clip. The application server 104 is further configured to determine one or more insights associated with the multimedia content based on the analysis of (i) the first multimedia clip and the corresponding first tag and (ii) the second multimedia clip and the corresponding second tag. The application server 104 is further configured to present on the organizer device 112, the one or more insights to the organizer 136.

A person of ordinary skill in the art will appreciate that embodiments and exemplary scenarios of the disclosed subject matter may be practiced with various computer system configurations, including multi-core multiprocessor systems, minicomputers, mainframe computers, computers linked or clustered with distributed functions, as well as pervasive or miniature computers that may be embedded into virtually any device. Further, the operations may be described as a sequential process, however, some of the operations may be performed in parallel, concurrently, and/or in a distributed environment, and with program code stored locally or remotely for access by single or multiprocessor machines. In addition, in some embodiments, the order of operations may be rearranged without departing from the spirit of the disclosed subject matter.

Techniques consistent with the disclosure provide, among other features, systems, and methods for tagging portions of the multimedia content. While various embodiments of the disclosed systems and methods have been described above, it should be understood that they have been presented for purposes of example only, and not limitations. It is not exhaustive and does not limit the disclosure to the precise form disclosed. Modifications and variations are possible in light of the above teachings or may be acquired from practicing the disclosure, without departing from the breadth or scope.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure.

What is claimed is:

1. A method, comprising:
recording, by an application server, a multimedia content that is indicative of a live user interview of a user;
determining, by the application server, a first alert associated with the multimedia content at a first time instance, wherein the first alert is indicative of a start of a portion of the multimedia content that is to be tagged;
determining, by the application server, a second time instance that corresponds to an end of the portion of the multimedia content that is to be tagged;
generating, by the application server, a first multimedia clip based on the multimedia content, wherein the first multimedia clip includes the portion of the multimedia content that is to be tagged;
identifying, by the application server, from a plurality of tags, a first tag that is indicative of a context of the first multimedia clip;
linking, by the application server, the first tag with the first multimedia clip; and
storing, by the application server, the first multimedia clip and the corresponding first tag in a memory associated with the application server.

2. The method of claim 1, wherein the first alert is determined based on detection of a trigger in the live user interview, and wherein the trigger includes at least one of a gesture, a facial expression, and one or more predefined keywords associated with the user in the live user interview.

3. The method of claim 1, wherein the first alert corresponds to an input received via an organizer device of an organizer of the live user interview while the multimedia content is being recorded.

4. The method of claim 1, wherein the start of the portion of the multimedia content that is to be tagged is at a gap of a predefined time interval from the first time instance.

5. The method of claim 1, further comprising receiving, by the application server, via an organizer device of an organizer of the live user interview, a second alert associated with the multimedia content at the second time instance, wherein the second alert is indicative of the end of the portion of the multimedia content that is to be tagged, and wherein the second time instance is determined by the application server based on the reception of the second alert.

6. The method of claim 5, wherein the second alert is received while the multimedia content is being recorded.

7. The method of claim 1, wherein the second time instance is determined by the application server to be at a predefined time duration after the first time instance.

8. The method of claim 1, further comprising:
identifying, by the application server, from the plurality of tags, a second tag that is indicative of the context of the first multimedia clip;
linking, by the application server, the second tag with the first multimedia clip; and
storing, by the application server, the first multimedia clip and the corresponding second tag in the memory associated with the application server.

9. The method of claim 1, further comprising:
storing, by the application server, the plurality of tags in the memory, wherein each tag of the plurality of tags is indicative of at least one context associated with the multimedia content; and
receiving, by the application server, via an organizer device of an organizer of the live user interview, a context indicator that is indicative of the context of the portion of the multimedia content to be tagged, wherein the first tag is identified from the plurality of tags based on the context indicator.

10. The method of claim 1, further comprising:
receiving, by the application server, a second tag via an organizer device of an organizer of the live user interview for the first multimedia clip;
linking, by the application server, the second tag with the first multimedia clip; and
storing, by the application server, the first multimedia clip and the corresponding second tag in the memory associated with the application server.

11. The method of claim 1, further comprising:
receiving, by the application server, after the first alert, a label via an organizer device of an organizer of the live user interview, wherein the label corresponds to one or more characteristics, that are different from the first tag, assigned to the portion of the multimedia content that is to be tagged;
linking, by the application server, the label with the first multimedia clip; and
storing, by the application server, in conjunction with the first multimedia clip and the first tag, the label in the memory associated with the application server.

12. The method of claim 1, further comprising:
receiving, by the application server, via an organizer device of an organizer of the live user interview, an input indicative of an instruction to delink the first tag from the first multimedia clip;
and updating the first multimedia clip and the corresponding first tag stored in the memory to delink the first tag from the first multimedia clip.

13. The method of claim 1, further comprising:
receiving, by the application server, via an organizer device of an organizer of the live user interview, an input indicative of an instruction to delink the first tag from the first multimedia clip and link a second tag to the first multimedia clip;
updating, by the application server, the first multimedia clip and the corresponding first tag stored in the memory to delink the first tag from the first multimedia clip;
linking, by the application server, the second tag with the first multimedia clip; and
storing, by the application server, the first multimedia clip and the corresponding second tag in the memory associated with the application server.

14. The method of claim 1, further comprising:
presenting, by the application server, on an organizer device of an organizer of the live user interview, the multimedia content having the first multimedia clip and the first tag; and
receiving, by the application server, via the organizer device, an input that verifies the first tag and the start and the end of the first multimedia clip.

15. The method of claim 1, further comprising, receiving, by the application server, over a communication network, the multimedia content from a user device of the user during the live user interview, wherein the live user interview is conducted for gathering user information regarding a domain of the live user interview from the user, and wherein the received multimedia content is recorded to enable the tagging of the multimedia content.

16. The method of claim 1, further comprising, receiving, by the application server, over a communication network, the multimedia content from an organizer device of an organizer of the live user interview, wherein the live user interview is conducted for gathering user information regarding a domain of the live user interview from the user, and wherein the received multimedia content is recorded to enable the tagging of the multimedia content.

17. The method of claim 1, further comprising receiving, by the application server, via an organizer device of an organizer of the live user interview, a domain of the live user interview, and the plurality of tags associated with the domain, wherein each tag of the plurality of tags is indicative of at least one of a subject, an objective, and a keyword associated with the domain of the live user interview.

18. The method of claim 1, further comprising:
generating, by the application server, a second multimedia clip that includes a portion of the multimedia content corresponding to a time interval between a third time instance and a fourth time instance;
identifying, by the application server, from the plurality of tags, a second tag that is indicative of a context of the second multimedia clip;
linking, by the application server, the second tag with the second multimedia clip;
determining, by the application server, one or more insights associated with the multimedia content based on an analysis of (i) the first multimedia clip and the corresponding first tag and (ii) the second multimedia clip and the corresponding second tag; and
presenting, by the application server, on an organizer device of an organizer of the live user interview, the one or more insights to the organizer.

19. A non-transitory computer-readable medium encoded with processor executable instructions that when executed by a processor perform steps of a method, the method comprising:
recording, by the processor, a multimedia content that is indicative of a live user interview of a user;
determining, by the processor, a first alert associated with the multimedia content at a first time instance, wherein the first alert is indicative of a start of a portion of the multimedia content that is to be tagged;
determining, by the processor, a second time instance that corresponds to an end of the portion of the multimedia content that is to be tagged;
generating, by the processor, a first multimedia clip based on the multimedia content, wherein the first multimedia clip includes the portion of the multimedia content that is to be tagged;
identifying, by the processor, from a plurality of tags, based on the first alert, a first tag that is indicative of a context of the first multimedia clip;
linking, by the processor, the first tag with the first multimedia clip; and
storing, by the processor, the first multimedia clip and the corresponding first tag in a memory associated with the processor.

20. A system, comprising:
a memory; and
an application server associated with the memory and configured to:
record a multimedia content that is indicative of a live user interview of a user;
determine a first alert associated with the multimedia content at a first time instance, wherein the first alert is indicative of a start of a portion of the multimedia content that is to be tagged;
determine a second time instance that corresponds to an end of the portion of the multimedia content that is to be tagged;
generate a first multimedia clip based on the multimedia content, wherein the first multimedia clip includes the portion of the multimedia content that is to be tagged;
identify, from a plurality of tags, a first tag that is indicative of a context of the first multimedia clip;
link the first tag with the first multimedia clip; and
store the first multimedia clip and the corresponding first tag in the memory.
